(19) United States
(12) Patent Application Publication
(10) Pub. No.: US 2024/0319405 A1
(43) Pub. Date: Sep. 26, 2024

(54) WEATHER PREDICTOR AND PREDICTION METHOD

(71) Applicant: ORBITAL MICRO SYSTEMS, INC., Boulder, CO (US)

(72) Inventors: Albin J. Gasiewski, Boulder, CO (US); Sang-Moo Lee, Seoul (KR); Michael Hurowitz, Longmont, CO (US); David Gallaher, Idaho Springs, CO (US); Robert Belter, Boulder, CO (US); Roger Carter, Boulder, CO (US); Sean McKee, Boulder, CO (US)

(21) Appl. No.: 18/611,459

(22) Filed: Mar. 20, 2024

Related U.S. Application Data
(60) Provisional application No. 63/453,403, filed on Mar. 20, 2023.

(51) Int. Cl. G01W 1/10; G01W 1/02

(52) U.S. Cl. CPC G01W 1/10; G01W 1/02

(57) ABSTRACT

A weather prediction method includes generating radiance differences as a difference between measured radiances from satellites and forecast satellite radiances generated by a radiative transfer model and forecasted state profiles output by a numerical weather prediction (NWP) model. When the radiance differences exceed a noise threshold, the method includes generating updated state profiles by generating radiance-sensitivities using a Jacobian model and the forecasted state profiles; constructing a Kalman-gain matrix from background error covariance (BEC) matrices and the radiance-sensitivities; generating filtered state-profile changes from the Kalman-gain matrix and the radiance differences; updating the state profiles by adding the filtered state-profile changes to the forecasted state profiles to yield updated state profiles.

### CROSS-REFERENCE TO RELATED APPLICATIONS

This application claims the benefit of U.S. Provisional Application No. 63/453,403, filed on Mar. 20, 2023, the disclosure of which is incorporated herein by reference in its entirety.

### GOVERNMENT RIGHTS

This invention was made with government support under a US Air Force Phase II SBIR, contract #FA9453-20-C-0713. The government has certain rights in the invention.

### BACKGROUND

Weather Forecasting models are currently limited in their ability to predict short term and small-scale weather effects in a zero to twelve hour range by making use of real-time data from passive microwave radiometer instruments due to the inability to properly utilize hydrometeor signatures within the data on a requisite 15 minute time scale. This has left open a range of market opportunities for improving industry and region-specific forecasts to handle a range of weather and climate change issues. Improving the accuracy of forecasts can enhance first responder operations, inform key financial and risk management industry decisions, optimize evacuations, and can be used to improve aircraft and ship route planning and weather effects mitigation. Highly localized weather forecasts are also critical for military operations globally.

### SUMMARY OF THE EMBODIMENTS

This inability has left open a range of market opportunities for improving industry and region-specific forecasts to handle a range of weather and climate change issues. Improving the accuracy of forecasts can enhance first responder operations, inform key financial and risk management industry decisions, optimize evacuations, and can be used to improve aircraft and ship route planning and weather effects mitigation. Highly localized weather forecasts are also critical for military operations globally.

In a first aspect, a weather prediction method is disclosed. The method includes generating radiance differences as a difference between measured radiances from satellites and forecast satellite radiances generated by a radiative transfer model and forecasted state profiles output by a numerical weather prediction (NWP) model. When the radiance differences exceed a noise threshold, the method includes generating updated state profiles by generating radiance-sensitivities using a Jacobian model and the forecasted state profiles; constructing a Kalman-gain matrix from background error covariance (BEC) matrices and the radiance-sensitivities; generating filtered state-profile changes from the Kalman-gain matrix and the radiance differences; updating the state profiles by adding the filtered state-profile changes to the forecasted state profiles to yield updated state profiles.

In a second aspect, a weather predictor includes a processor and a memory. The memory stores machine-readable instructions that, when executed by the processor, control the processor to execute the weather prediction method of the first aspect.

### BRIEF DESCRIPTION OF THE FIGURES

FIG. 1 shows a basic data assimilation procedure being implemented by embodiments of weather predictors disclosed herein.

FIG. 2 is schematic of a weather predictor, in an embodiment.

FIG. 3 is a functional block diagram of an example data assimilator implemented by the weather predictor of FIG. 2, in an embodiment.

FIG. 4 is a flowchart illustrating a weather prediction method, which may be implemented by the weather predictor of FIG. 2, in an embodiment.

FIGS. 5A-5D illustrate respective hydrometeor profiles partitioned into K=20 clusters at four time frames by an embodiment of the weather predictor of FIG. 2.

FIGS. 6A-6D illustrate respective hydrometeor profiles partitioned into K=10 clusters at four time frames by an embodiment of the weather predictor of FIG. 2.

FIG. 7 graphically illustrates Jacobian functions generated by the weather predictor of FIG. 2 using a linear radiative transfer model.

FIG. 8 graphically illustrates vertical hydrometeor distributions for a precipitating profile used for hydrometeor Jacobian tests.

FIG. 9 graphically illustrates Jacobians functions obtained using a linear radiative transfer model for rain phase hydrometeors and the hydrometeor profile observed for Hurricane Sandy, 29 Oct. 2012

FIG. 10 graphically illustrates Jacobians functions obtained using a linear radiative transfer model for cloud ice phase hydrometeors and the hydrometeor profile observed for Hurricane Sandy, 29 Oct. 2012.

FIG. 11 shows the physical location of cluster #3 in the first frame of the Midwest storm

FIG. 12 shows that correlation matrix of cluster #3.

### DETAILED DESCRIPTION OF THE EMBODIMENTS

### 1 Summary

The ability to lock a numerical weather prediction (NWP) model's hydrometeor state onto satellite data to provide quantitative predictions of such events requires the data to be sampled at intervals no longer than the correlation time for hydrometeor variables in precipitating events. It also requires that the satellite data be sensitive to the presence of hydrometeors beneath cloud tops, which is a key advantage of passive microwave sounding and imaging channels relative to infrared channels. It further requires that the data be of spatial resolution comparable to or nearly the horizontal spatial scale of convective events, approximately 10-15 kilometers. All of these features may be designed into systems and methods disclose herein.

### 2 Weather Predictor and Method

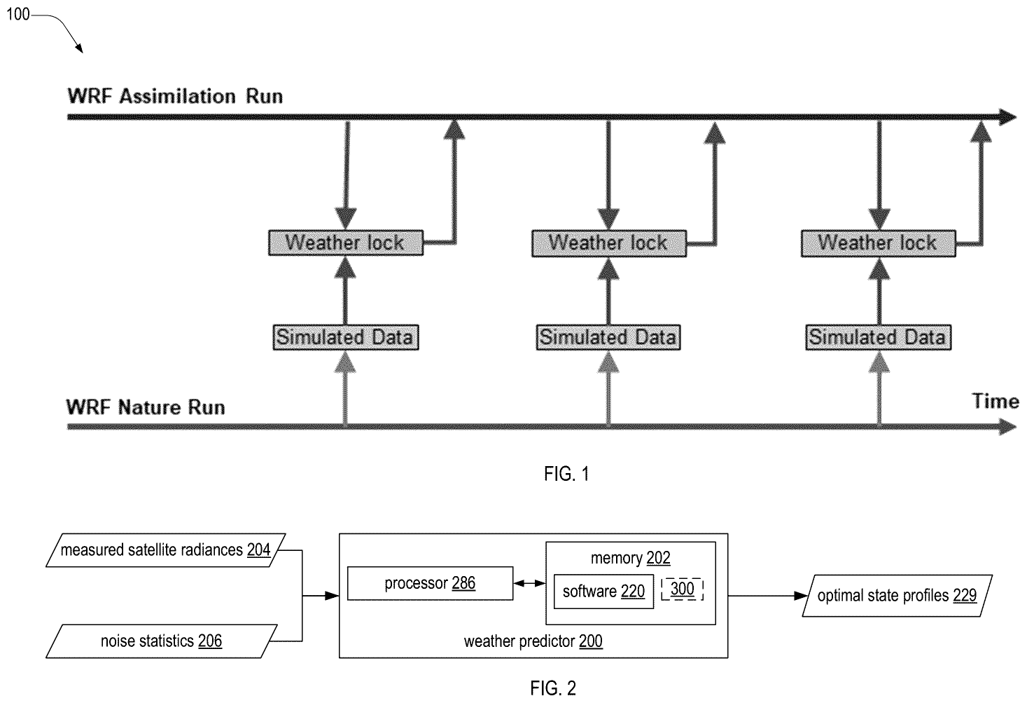

FIG. 1 shows an example basic data assimilation procedure 100 being implemented by embodiments disclosed herein. In general, any of several NWP models that incorporate explicit cloud and precipitation microphysical models such as Global Air-Land Weather Exploitation Model (GALWEM), Global Forecast System (GFS), and Weather Research and Forecast (WRF) model may be used. The selection of the WRF model for developing weather predictor 200 was based on its general reliability, open accessibility, numerical efficiency, scalability, and ability to be incorporated into loop-based assimilation schemes.

The WRF model was used to simulate the combined hydrometeor and thermodynamic state of the atmosphere on a regional basis through the generation of several case study “nature” and “assimilation” runs. The nature run represents the ‘truth’ for the test weather scenario, which is used to create simulated (i.e., artificial but realistic) state data that are the basis for the observed brightness temperature (T_{b}) data expected from the GEMS satellite constellation. In the assimilation runs, we perturb the nature run and use the simulated data and the weather prediction method to converge or “lock” the NWP state vector onto the truth weather state vector, as observed by the GEMS constellation. The process is thus an Observing System Simulation Experiment (OSSE) for the GEMS passive microwave sensor constellation used in a rapid-update all-weather three-dimensional variational (3Dvar) eXtended Kalman Filter (XKF) assimilation scheme.

### 2.1 Weather Predictor

FIG. 2 is schematic of a weather predictor 200 that outputs converged state profiles 229 from measured satellite radiances 204 and noise statistics 206. Weather predictor 200 includes a processor 286 and a memory 202. Noise statistics 206 includes statistics on noise from satellites that generate measured satellite radiances 204.

In embodiments, forecasted state profiles 319 include, for each of a plurality of horizontal grid points within a regionally defined domain, vertical state profiles of at least one of air temperature, humidity, altitude, hydrometeor density, and hydrometeor size. Weather predictor 200 may be communicatively coupled to a satellite constellation, e.g., the aforementioned GEMS satellite constellation. Measured satellite radiances 204 may be data measured by the satellite constellation.

Processor 286 represents any type of circuit or integrated circuit capable of performing logic, control, and input/output operations. For example, processor 286 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC). Processor 286 may also include a memory controller, bus controller, and other components that manage data flow between processor 286, memory 202.

Memory 202 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 202 may be integrated into processor 286. Memory 202 stores software 220 that includes non-transitory machine-readable instructions. When executed by processor 286, software 220 causes processor 286 to implement the functionality of weather predictor 200 as described herein. Software 220 may be, or include, firmware.

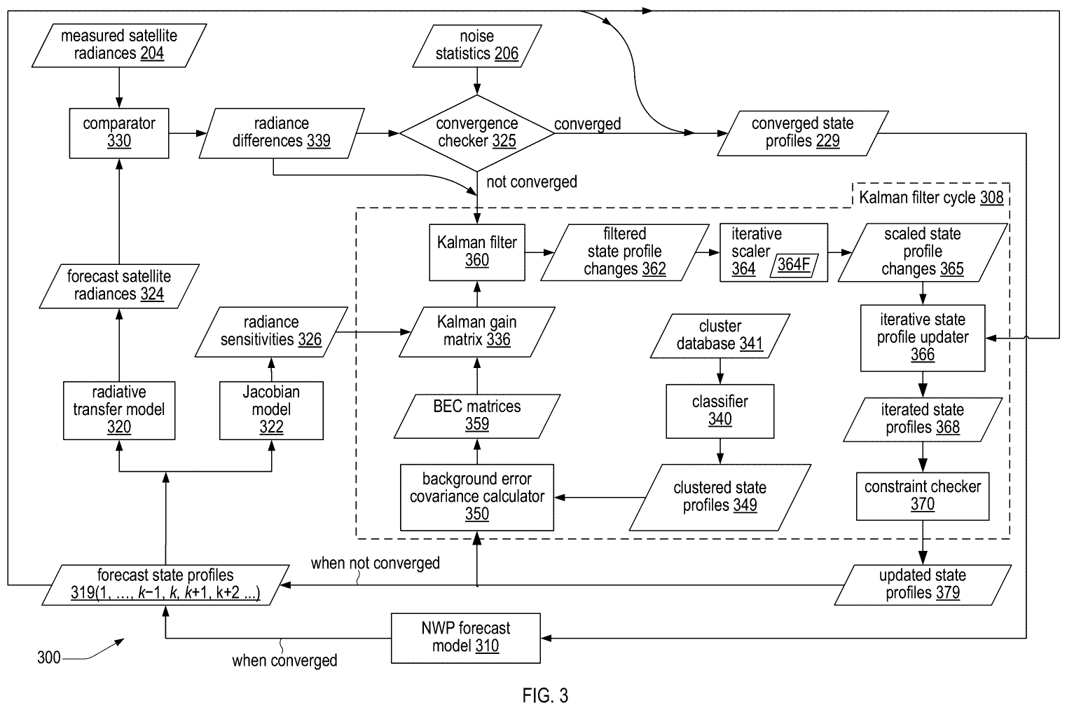

FIG. 3 is a functional block diagram of a data assimilator 300, which may be executed by embodiments of weather predictor 200. Functional elements of data assimilator 300 may be stored as software 220, while data accessible to and/or generated by data assimilator 300 may be stored in memory 202. Functional elements of data assimilator 300 includes a radiative transfer model 320, a Jacobian model 322, a convergence checker 325, a comparator 330, an NWP forecast model 310, a classifier 340, a BEC calculator 350, a Kalman filter 360, an iterative scaler 364, an iterative state profile updater 366, and a constraint checker 370. Data accessible to and/or generated by data assimilator 300 includes measured satellite radiances 204, noise statistics 206, radiance differences 339, converged state profiles 229, forecast satellite radiances 324, forecasted state profiles 319, radiance sensitivities 326, filtered state profile changes 362, scaled state profile changes 365, iterated state profiles 368, background error covariance (BEC) matrices 359, a Kalman-gain matrix 336, a cluster database 341, clustered state profiles 349, and updated state profiles 379. Data assimilator 300 includes a Kalman filter cycle 308, which includes some of the aforementioned functional elements and data. Data assimilator 300 may run Kalman filter cycle 308 as an iterative loop.

The following describes an example operation of an embodiment of data assimilator 300 as implemented by an embodiment of weather predictor 200. Weather predictor 200 receives satellite radiances 204 and processes them by radiometric calibration methods to high precision. These radiances, also known as brightness temperatures, are provided by the satellites at one or more of several different frequencies. These frequencies are associated with the key natural features of the Earth's radiance spectrum and include microwave frequencies at various gaseous resonance frequencies, as well as frequencies in between these resonances that permit transmission through the atmosphere to the surface. The frequencies may also include infrared and optical wavebands in addition to microwave frequencies. The satellite data may be provided in data cubes which are stacks of two-dimensional images with one such image at each frequency. Other formats are also possible.

Comparator 330 compares satellite radiances 204 with an equivalent set of forecast satellite radiances 324 that have been predicted for each specific satellite using radiative transfer model 320. Initial forecast radiances 324 may be obtained from estimates of the forecast state profiles 319 and processed by a radiative transfer model 320. These initial estimates may be obtained from either other numerical weather prediction (NWP) models operated, for example, by government services or by other actual atmospheric observations made using satellites, radars, weather balloons, or other instruments.

Forecast radiances 324 are subtracted from satellite radiances 204 using comparator 330 to form radiance differences 339. Radiance differences 339 are used to correct the state profiles to produce converged state profiles 229, which are used to further forecast the atmospheric state using numerical weather forecast model 310. Any of several forecast models, for example, the Weather Research and Forecast (WRF) model may be used by NWP model 310.

When the radiance differences 339 are statistically indistinguishable from noise statistics 206, then no further information can be derived from radiance differences 339. Noise statistics 206 may include a matrix root-sum-square of the noises from all of (1) satellites that produce measured satellite radiances 204, (2) radiative transfer model 320, and (3) NWP model 310. This root-sum-square comparison testis performed by convergence checker 325, which tests for algorithm convergence by comparing radiance differences 339 to noise statistics 206. Noise statistics 206 may be the root-sum-square statistical noise covariance at all frequencies and 2-dimensional image pixels, as shown on the right side of equation (1). The convergence testis described using equation (2.1):

$$( \overline{y} - \overline{W} ( \overline{x} ) ) {( \overline{y} - \overline{W} ( \overline{x} ) )}^{t} \leq {{R}^{=}}_{nn} + {{R}^{=}}_{rr} + {{R}^{=}}_{σ σ} \qquad ( 2.1 )$$

Terms of equation 1 are defined as follows:
x̅ is a forecast state profile vector;
y̅ is a measured satellite radiance vector;
W̅ is radiative transfer model function;
R̅ₙₙ is a satellite radiance error covariance matrix;
R̅ᵣᵣ is a radiative transfer model error covariance matrix;
R̅_{σσ} is a forecast state profile radiance error covariance matrix.
   Superscript t represents the transpose operator. A single overbar indicates a vector quantity and double overbar indicates a matrix quantity.

In the case of successful convergence, data assimilator 300 proceeds with current forecast state profiles 319 being passed back to NWP model 310, e.g., through the copying and transfer of these profiles to NWP model 310 as converged state profiles 229. NWP model 310 then proceeds to forecast the atmospheric state appropriate for the next time of satellite observation. Data assimilator 300 may use enough satellites so that the time interval between consecutive observations is typically within several minutes, but may be as long as three hours depending on how many satellites are available.

Since the atmosphere likely evolves by the time of next satellite observation, convergence checker 325 likely shows non-convergence. In this case, the information in radiance differences 339 is used to correct the atmospheric state profile through a Kalman filter 360 and associated processes of Kalman filter cycle, which are used to provide key information to Kalman filter 360.

The filtering algorithm proceeds as follows. Jacobian model 322 computes radiance sensitivities 326 from forecasted state profiles 319. Radiance sensitivities 326 effectively provide the sensitivity of all brightness temperatures to small variations in each atmospheric state profile variable. A fast and accurate means of calculating these sensitivities for all types of atmospheric states (clear air, clouds, stratiform rain, convective rain, etc.) is important to the operation of the filtering algorithm. Jacobian model 322 may include algorithms that provide solutions to the radiative transfer equation (e.g. used by radiative transfer model 320), and may also include libraries, look-up tables, and machine learning and artificial intelligence algorithms that calculate these radiance sensitivities 326.

Radiance sensitivities 326 are used along with suitable set of background error covariance (BEC) matrices 359 to construct Kalman gain matrix 336. The number of BEC matrices in the set may be determined at least in part by the number required to span the set of weather conditions for a given area of the globe. In embodiments, BEC matrices 359 includes between twenty and twenty-five BEC matrices.

In embodiments, each pixel or subset of pixels in the radiance difference data cube or data volume (included in radiance differences 339) may have a distinct Kalman gain matrix constructed so Kalman gain matrix 336 may include a number of Kalman gain matrices. Kalman filter 360 uses Kalman gain matrix 336 and radiance differences 339 to determine a set of filtered state profile changes 362 by matrix multiplication. Filtered state profile changes 362 may be expressed by Δx̅_{n′} defined in equation (2.2), where D̅ₙ is a Kalman gain matrix.

$$Δ {\overline{x}}_{{n}^{′}} = {{D}^{=}}_{n} ( \overline{y} - \overline{W} ( {{x}^{\hat{\_}}}_{n} ) ) \qquad ( 2.2 )$$

Filtered state profiles changes 362 undergo at least one of processing steps (scaling by iterative scaler 364 and imposing physics-based constraints by iterative state profile updater 366) before they are used as updated state profiles 379. These steps may be used as is necessary to maintain the physical suitability of iterated state profiles 368 prior to their being used in Kalman filter cycle 308.

The processing steps include determining an iterative scaling factor 364F based on a measure of expected accuracy of Jacobian model 322, which provides only a linear relationship between radiance and the state profile quantities. Iterative scaler 364 determines this accuracy for each state profile based on the degree of linearity of the relations between one or more of following state profile quantities as a function of radiance (satellite brightness temperature): temperature, humidity, and cloud and rain parameters. Scaling factor 364F may be between zero and one, inclusive.

The linearity is estimated in the Jacobian model 322 when the sensitivities are calculated. Scaling factor 364F, which is generally different for each pixel or group of pixels, is applied to scale the state profile changes to yield scaled state-profile changes 365, which may be expressed by Δx̅ₙ defined in equation (2.3).

$$Δ {\overline{x}}_{n} = α Δ {\overline{x}}_{{n}^{′}} = α {{D}^{=}}_{n} ( {\overline{y}}_{i} - \overline{W} ( {{x}^{\hat{\_}}}_{n} ) ) \qquad ( 2.3 )$$

In equation 2.3 measured satellite radiance vector y̅ is indexed by a subscript i, such that y̅ᵢ denotes the i^{th} observation or measurement.

Iterative state profile updater 366 adds scaled state profile changes 365 forecasted state profiles 319 (\hat{x}ₙ). This yields a candidate set of iterated state profiles 368, which may be expressed by \hat{x}ₙ₊₁ defined in equation (2.4)

$${\hat{x}}_{n + 1} = {\hat{x}}_{n} + Δ {\overline{x}}_{n} \qquad ( 2.4 )$$

In embodiments, before the iterated profiles 368 are adopted, they are checked for consistency with the laws of conservation of energy, momentum, and mass by intercomparison by constraint checker 370. Only those state profiles 368 that comply with conservation laws are propagated as corrections to produce updated state profiles 379, which are further used within Kalman filter cycle 308. The scaling, iterative update, and conservation constraint elements (scaler 364, updater 366, and constraint checker 370) applied to all state profile variables including temperature, humidity, cloud and rain, and surface parameters are key features of embodiment of data assimilator 300.

During each cycle of Kalman filter cycle 308, updated state profiles 379 are used to determine an updated set of BEC matrices 359. BEC matrices 359 are dynamically dependent on the atmospheric state and are regenerated as needed (e.g., by classifier 340, database 341, profiles 349, and BEC calculator 350) as the state profiles \hat{x}ₙ are updated. For stable and clear air atmospheric conditions, the BEC generation by BEC calculator 350 results in relatively small error being predicted for variables such as cloud and rain content, thus focusing Kalman gain matrix 336 on correcting other parameters such as temperature and humidity.

However, during dynamically evolving atmospheric conditions such as those occurring in convective rain, BEC matrices 359 likely result in large errors in cloud and rain cell profile parameters, thus focusing the Kalman gain matrix 336 on correcting parameters such as cloud and rain density. In this manner, the BEC matrix generation steers the use of measured satellite radiances 204 and NWP model 310 to take advantage of the frequent satellite radiance observations.

BEC calculator 350 rapidly calculates BEC matrices 359 using a state-profile database 341, which is fed into classifier 340. Database 341 includes many atmospheric state profiles. This ensemble of profiles in database 341 may be representative of likely atmospheric state profiles that might occur within a given region of the globe for a given season of the year.

In embodiments, classifier 340 uses standard means of data clustering, such as the K-means algorithm, to facilitate classification of updated state profiles 379, by BEC calculator 350, into a small number of possible atmospheric conditions as categorized in clustered state profiles 349. In embodiments, each clustered state profile 349 has a specific pre-computed BEC matrix that captures the statistics of these possible atmospheric conditions. These atmospheric state profile statistics may be obtained from either (a) a long series of NWP model simulations of weather in a given region and for a given season or (b) actual atmospheric observations made using satellites, radars, weather balloons, or other instruments.

These statistics are used by BEC calculator 350 to express the statistics of specific state profile 379 for Kalman filter cycle 308. BEC calculator 350 generates BEC matrices 359 by using calculations of the covariances of clustered state profiles 349 for updated state profile 379. The classification of updated state profiles 379 permits either interpolation, library look up, or machine learning generation of the BEC matrices from clustered state profiles 349. BEC calculator 350 may include a neural network trained on clustered state profiles 349 to generate BEC matrices 359.

The development of clustered state profiles database 341 may occur offline and produces a static database. However, database 341 and profiles 349 may be regularly revised and updated as new information on possible atmospheric state profiles becomes available and according to either seasonal or climate changes that occur on both slow and fast time scales. For example, new cluster data may be incorporated as the planet transitions between stationary El Niño and La Niña states.

During each iteration of Kalman filter cycle 308, data assimilator 300 recomputes forecast satellite radiances 324, takes their difference 339, and, using convergence checker 325, checks for convergence. Convergence may occur either by reducing the differences 339 to the level of noise statistics 206 or after a fixed number of iterations of Kalman filter cycle 308 (which ever occurs first). A fixed number of iterations may be used in the event that new satellite radiances arrived before the Kalman filter loop had reached convergence by adjustment of the state profiles. Upon convergence, data assimilator 300 accepts the latest forecast state profiles 319 as converged state profiles 229, and then proceeds to forecast the state profiles (as state profiles 319(k+1)) to accommodate the arrival of the next set of satellite radiances 204.

When each of (a) satellite radiances 204 are observed and assimilated frequently enough, (b) state profiles 379 are updated often enough, and (c) the Jacobian model 322 and BEC error covariance calculator 350 are used during each update to provide accurate error covariance, the data assimilator 300 is locked to continuously track small variations in the actual atmospheric state profile.

Locking of data assimilator 300 onto rapidly evolving atmospheric state profile changes associated with clouds and rain in dynamically evolving storm conditions is one of its key technical benefits. When data assimilator 300 is locked, it uses the satellite radiances' responses to all atmospheric conditions and track evolving conditions that would otherwise cause highly erroneous forecast radiances, especially dynamically evolving conditions of rain and weather frontal events. A key feature of data assimilator 300 is that when locked, using frequent satellite radiance updates, the algorithm obviates the need for four-dimensional variational assimilation of data into NWP models, which is known to be at best of limited accuracy due the major changes in atmospheric state that can occur during dynamic conditions.

### 2.2 Weather Prediction Method

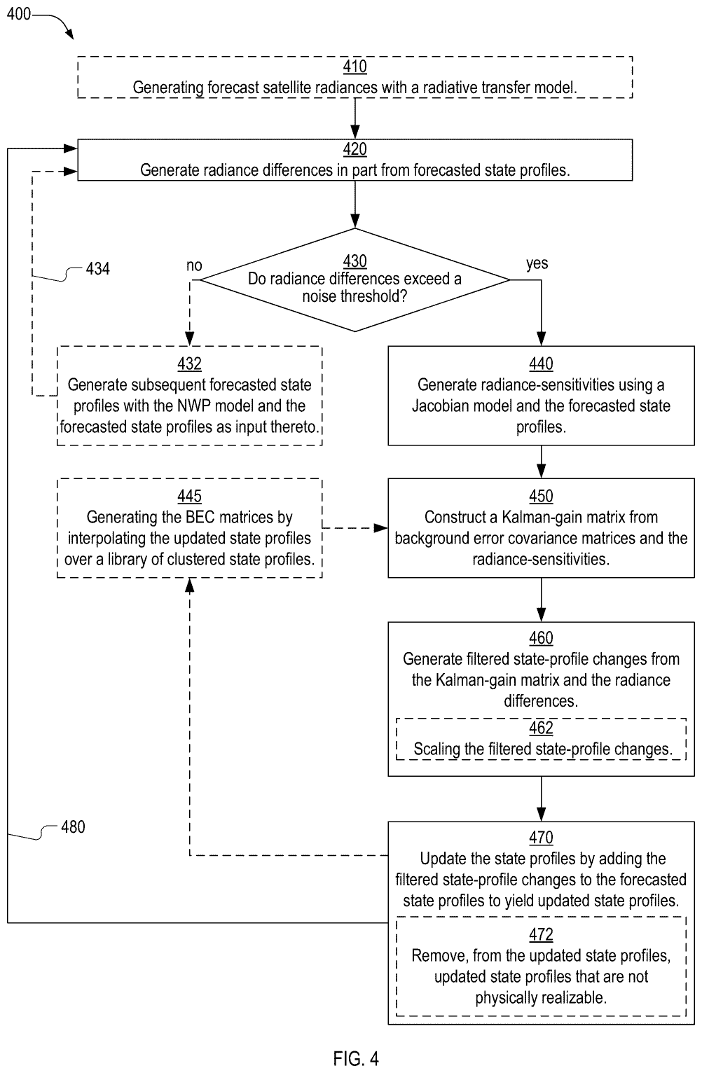

FIG. 4 is a flowchart illustrating a weather prediction method 400. Method 400 may be implemented, at least in part, within software 220 of weather predictor 200 of FIG. 2. Method 400 includes at least one of steps 420, 430, 440, 450, 460, and 460. Method 400 may also include at least one of steps 410, 432, 445, and 480.

Step 420 includes generating radiance differences as a difference between measured radiances from satellites and forecast satellite radiances generated by a radiative transfer model and forecasted state profiles output by a numerical weather prediction (NWP) model. In an example of step 420, comparator 330 generates radiance differences 339(k) as a differences between measured radiances 204 and forecast satellite radiances 324(k−1) generated by radiative transfer model 320 and forecasted state profiles 319(k−1). Herein, index k denotes the k^{th} iteration of data assimilator 300. In embodiments, each iteration begins with the generation of radiance differences 339.

Method 400 may include a step 410. Step 410 includes, before generating the radiance differences, generating the forecast satellite radiances with the radiative transfer model. In an example of step 410, radiative transfer model 320 generates forecast satellite radiances 324(k−1).

Step 430 is a decision. When the radiance differences exceed a noise threshold, method 400 proceeds with steps 440, 450, 460, and 460, which yield updated state profiles. For example, in iteration k, when radiance differences 339(k) exceed a noise threshold based on noise statistics 206, data assimilator 300 produces updated state profiles 379(k). Noise statistics 206 may include noise associated with radiative transfer model 320. The noise threshold may be root-mean-squared (RMS) of the noise from instruments (e.g., satellites) and from radiative transfer model 320.

Step 440 includes generating radiance-sensitivities using a Jacobian model and the forecasted state profiles. In example of step 440, Jacobian model 322 generates radiance sensitivities 326 from forecasted state profiles 319(k−1).

Step 450 includes constructing a Kalman-gain matrix from background error covariance (BEC) matrices and the radiance-sensitivities. In an example of step 450, data assimilator 300 constructs Kalman-gain matrix 336 from BEC matrices 359 and radiance sensitivities 326.

Method 400 may include step 445. Step 445 includes generating the background error covariance (BEC) matrices by interpolating the updated state profiles over a library of clustered state profiles obtained by a classification method. Examples of the classification method include k-means clustering. In an example of step 445, BEC calculator 350 generates BEC matrices 359 by interpolating updated state profiles 379 over a library of clustered state profiles 349. This library may include BEC matrices. Classifier 340 may generate clustered state profiles 349 from cluster database 341.

Step 460 includes generating filtered state-profile changes from the Kalman-gain matrix and the radiance differences. In example of step 460, Kalman filter 360 generates filtered state profile changes 362 from Kalman-gain matrix 336 and radiance differences 339. The filtered state-profile changes may be a product of the Kalman-gain matrix and the radiance differences.

Step 460 may include step 462, in which the generated filtered state-profile changes are unscaled filtered state-profile changes. Step 462 includes scaling the unscaled filtered state-profile changes, e.g., by iterative scaling factor 364F, to yield the filtered state-profile changes.

Step 470 includes updating the state profiles by adding the filtered state-profile changes to the forecasted state profiles to yield updated state profiles. In an example of step 470, iterative state profile updater 366 adds scaled state profile changes 365 to forecasted state profiles 319(k−1) to yield iterated state profiles 368(k). Step 470 may include step 472. Step 472 includes removing, from the updated state profiles, updated state profiles that are not physically realizable. In example of step 472, constraint checker 370 removes physically unrealizable state profiles from iterated state profiles 368(k) to yield updated state profiles 379.

When the radiance differences exceed a noise threshold, method 400 may also include step 480. Step 480 includes repeating the step of generating radiance differences, where the updated state profiles replace the forecasted state profiles In an example of step 480, data assimilator 300 replaces forecasted state profiles 319(k−1) with updated state profiles 379(k) to yield forecasted state profiles 319(k), and repeating step 420 using forecasted state profiles 319(k). Subsequent steps of method 400 may be repeated after step 420 is repeated.

When the radiance differences output from step 420 do not exceed a noise threshold, embodiments of method 400 proceed to steps 432 and 434. Step 432 includes generating subsequent forecasted state profiles with the NWP model and the forecasted state profiles as input thereto. In an example of step 432, convergence checker 325 outputs converged state profiles 229, from which NWP forecast model 310 generates forecasted state profiles 319(k+1). Converged state profiles 229 may be equal to forecasted state profiles 319(k). Step 434 includes repeating the step 420, where the subsequent forecasted state profiles replace the forecasted state profiles. In step 434, forecasted state profiles 319(k+1) output from step 432 are examples of the subsequent forecasted state profiles.

In embodiments, the forecasted state profiles include, for each of a plurality of horizontal grid points within a regionally defined domain, vertical state profiles of a plurality of state profile variables. The plurality of state profile variables may include at least one of air temperature, humidity and one or more additional state profile variables. Examples of additional state profile variables include: altitude, hydrometeor density, hydrometeor size, vapor density, cloud content density, rain content density, ice content density, snow content density, graupel content density, mean rain particle size, mean ice particle size, and mean hydrometeor size. In embodiments, the plurality of state profile variables may includes both air temperature and humidity, and one or more aforementioned additional state profile variables. Each of the plurality of state profile variables has a respective one of a plurality of correlation times.

In such embodiments, step 470 may include updating each state profile variable of the vertical state profiles of forecasted state profiles 319. Also in such embodiments, when constructing the Kalman-gain matrix, each BEC matrix of the BEC matrices (e.g., BEC matrices 359) includes a covariance between each state profile variable of the plurality of state profile variables.

A time duration between consecutive executions of step 470 (iterations k and k+1 for example) may be less than the shortest correlation time of the plurality of correlation times. The time duration may be adjusted in real time according to whether or not the atmospheric is particularly dynamic over a given region (e.g., a tornado or a frontal boundary). The time duration may be between one minute and three hours, depending on environmental conditions. Example time durations include one to five minutes for tornadic supercells, derechos, or hail-producing storms, five to fifteen minutes for frontal convection, microburst producing clouds, or hurricane rainbands, fifteen minutes to thirty minutes for downslope winds such as foehns, thirty to sixty minutes for stratiform precipitation or snowfall events, two hours to three hours for overcast non-precipitating clouds.

### 2.3 Nature Runs

The OSSEs use XKF data assimilation performed by weather predictor 200 to investigate the forecast impacts of the GEMS constellation of passive microwave satellites. The satellites have sounding channels at the primary 118, 183, and 50-58, and 424 GHz microwave sounding bands. The forecast impact of GEMS is assessed by considering the reduction in (primarily) 1-12 hour forecast anomalies resulting from the use of simulated GEMS data to bring a NWP model whose state vector has been perturbed back toward the truth for all thermodynamic and hydrometeor variables. The OSSEs thus provide a means to quantitatively assess the data impact on short-term precipitation forecasts, which are of both strategic and commercial interest.

### 3.0 Methods, Assumptions, and Procedures

### 3.1 UMRT Forward Radiative Transfer Model

Radiative transfer model 320 may use or include the Unified Microwave Radiative Transfer (UMRT v4) model [1] as the forward radiative transfer model used to calculate the upwelling polarized radiances at the top of the atmosphere. UMRT is a coupled multi-stream dual-polarization (V and H) scattering-based RT model that uses a slab doubling engine inherited from the inherently stable Discrete Ordinate Tangent Linear Radiative Transfer (DOTLRT) model [2]. DOTLRT was used to calculate the initial T_{b} simulations, with the new UMRTv4 model being refined for operational use. In embodiments, it supports a rapid Jacobian calculation, e.g., by Jacobian model 322, that provides the derivatives of all radiances with respect to any profile radiative parameter.

This rapid Jacobian calculation may follow the perturbation method implemented within the DOTLRT model. Table 1 lists the profile parameters provided to UMRT from the WRF model. UMRT had originally been formulated to use an exponential size distribution for each of five hydrometeor species (rain cloud liquid water, cloud ice, snow, and graupel) based on observed particle size spectra. The UMRT v4 model may be modified to use any size distribution. In embodiments, the size distribution is exponential, as it is the simplest from a mathematical perspective and because it captures a great deal of the physics of absorption and scattering from a polydispersion of naturally occurring hydrometeors.

The use of exponential distributions is justified for testing embodiments of weather predictor 200, since they were performed in a closed environment and can in principle adopt any reasonable physics. For characterizing embodiments of weather predictor 200, a WRF microphysical hydrometeor parameterization providing cloud liquid, rain, ice, and graupel mass densities is used, however, only rain and ice number densities are available to provide a complete and unique exponential size distribution.

For cloud liquid and graupel the mean particle sizes are obtained using empirical models. In addition to hydrometeors, UMRT uses vertical profiles of temperature and humidity from the WRF model.

UMRT uses the Millimeter-wave Propagation Model (MPM) [3] to calculate gaseous absorption from water vapor, oxygen, and nitrogen, and Mie scattering theory to calculate the hydrometeor absorption and scattering coefficients and phase matrix elements. Equivalent liquid or frozen water spheres are thus used to approximate all hydrometeors. The calculation of the Mie absorption and scattering coefficients for exponential spherical hydrometeor distributions utilizes a tabularized library [1] and proceeds rapidly. However, Mie phase matrix calculations have not yet been tabularized and thus require a significant amount of computer time to complete on the University of Wisconsin multi-core machine (typically about 100-1000 times that required for real-time operational implementation on similar machines). As a means of achieving speed improvements, the computationally simpler Henyey-Greenstein (HG) phase function [4] may substituted for the Mie phase matrix in radiative transfer model 320. This substitution helped achieve a roughly 2× improvement in computation time. Reducing the number of radiance streams from 16 to 8 resulted in a speedup of a factor of four per profile.

TABLE 1
Input parameters to the UMRT v4 forward
RT model at each of 74 pressure levels

| Number | Class | Parameter | Description |
|---|---|---|---|
| 1 | Atmosphere | Temperature | Air temperature |
| 2 | Atmosphere | Pressure | Air pressure |
| 3 | Atmosphere | Humidity | Absolute humidity |
| 4 | Hydrometeor | CLW density | Cloud liquid water density |
| 5 | Hydrometeor | Rain density | Precipitation density |
| 6 | Hydrometeor | Ice density | Cloud ice density |
| 7 | Hydrometeor | Graupel density | Graupel density |
| 8 | Number Density | Qᵣₐᵢₙ | Liquid particle number |
| | | | density |
| 9 | Number Density | Q_{ice} | Ice particle number density |

Multistream predicted radiances using UMRT from the Midwest storm nature run reveal anticipated characteristics for emission of radiation from scattering and absorbing clouds and rain cells. These radiance fields are strongly dependent on the microwave gaseous background absorption, and hence the microwave channel frequency. High frequency channels near the 183.31 GHz water vapor resonance show expected cooling over regions of moist upper air and limb darkening of radiances at high stream incidence angles. These shallow-angle streams show particularly high sensitivity to tall convective clouds and only moderate path-integrated scattering at steeper (i.e., nearer zenith) stream angles. In all cases clouds and rain cells are more prominent and have higher signal-to-noise ratio features at high frequencies than at lower microwave frequency bands. In embodiments, Jacobian model 322 accounts for these characteristics the calculation of the Jacobian for precipitating regions, which is a function of the footprint observation angle, polarization, and channel sub-band center frequency.

The surface background radiometric emission model used in UMRT is currently that of a simple specularly reflecting surface where land is considered to be at a fixed 95% emissivity and water (both ocean and lake) is considered to be 55% emissivity. For a Midwest storm system nature run, most of the background is land, which renders the low-peaking 118- and 183-GHz weighting functions to be relatively insensitive to lower-tropospheric temperature and water vapor. However, mid- to upper-tropospheric clouds and rain cells provide strong radiometric cooling due to both absorption by liquid hydrometeors and scattering by cloud ice. Precipitation is thus readily observed in the microwave imagery, which in embodiments forms the basis of an innovation variable (e.g, radiance differences 339) used in Kalman filter cycle 308.

### 3.2 Constellation Simulator

Weather predictor 200 may use simulated upwelling T_{b} data derived from the geophysical state data of the NRs to simulate the GEMS satellite Tₐ observations. This simulated Tₐ data is artificial and calculated from UMRT T_{b} model output. In embodiments, the spatial resolution, the temporal resolution, and polarization of simulated Tₐ data is identical to that of the calibrated Tₐ values expected from the planned GEMS constellation. Data assimilator 300 may calculate the Tₐ values that a typical GEMS satellite would observe. In embodiments, the innovations used in the assimilation process (e.g., radiance differences 339) are thus effectively calculated as main beam Tₐ differences.

Each GEMS satellite swath is ˜2000 km wide, or ±1000 km relative to the ground track. Each cross-track raster has 83 overlapping footprint samples. With a 500 km orbit altitude, the sample footprints have a ˜20 km 3 dB radius at nadir, increasing to 40 km near the limb of the Earth, which makes the cross-track footprint raster coverage a slightly hourglass-shaped locus of points. All sample footprints are mapped for all satellites onto the WRF latitude and longitude grid in a nature run and interpolated in time and linear polarization in between bounding analysis times. This mapping provides a set of weights that are used to implement numerical quadrature on the simulated upwelling T_{b} values to obtain simulated main beam Tₐ swaths. Coefficients of this linear algorithm form the instrument Jacobian and are essential to computing, in data assimilator 300, the full Jacobian (with Jacobian model 322) and Kalman gain matrix 336 for generating updated state profiles 379.

### 3.3 Unsupervised Hydrometeor State Clustering

In embodiments, an important component of the Kalman gain matrix needed for Kalman filter cycle 308 is a flow dependent BEC matrix (e.g. as one of BEC matrices 359) relevant for all state vector profile parameters. The relevant parameters not only include the commonly assimilated variables of temperature and humidity, but also all NWP model hydrometeor parameters. The BEC for these hydrometeor parameters is highly state (or, flow) dependent, and thus needs to be generated based on the local state vector of the atmosphere. As such, the Kalman gain may be calculated when the model state is close to the actual state (i.e., when data assimilator 300 is “locked”). Use of Kalman gain matrix 336) in turn leads to the most accurate use of the innovations, which in turn serves to keep the model state locked.

Embodiments of data assimilator 300 enable rapid generation of a flow-dependent BEC matrix (e.g., of BEC matrices 359) for temperature, humidity, and all hydrometeor variables (a total of eight parameters using the selected WRF hydrometeor microphysical scheme). In embodiments, BEC matrices 359 couple these eight parameter-vector errors, and may presume Gaussian error statistics. While it is well known that atmospheric variables are non-Gaussian over large excursions, Gaussian statistics are nonetheless reasonable to assume for small departures of these variables from the truth. Indeed, such small departures are condition achievable when the model is locked.

However, BEC matrices 359 may also couple errors at all vertical levels and (ideally, in its most complete form) over a horizontal range of distance sufficient for estimating these parameter departures statistically using only a small number of overlapping footprints of observed satellite data. That is, the horizontal range described by BEC matrices 359 may cover the satellite footprint and describe the horizontal correlation distance of hydrometeor parameters, which varies according to the type of cloud or rain event. In embodiments, stratiform precipitation requires a BEC matrix (of BEC matrices 359) that couples errors horizontally to distances of perhaps up to ˜100 km, or several microwave footprints, while convective precipitation will only couple errors out to several kilometers, or well within a microwave footprint. Without such horizontal range restrictions applied to certain embodiments, the size of BEC matrices 359 and Kalman gain matrices 336 would grow to unacceptable and unnecessary size.

In the midwestern storm case, the size of the background error covariance matrix for the entire domain is of order ˜5×10⁷ by 5×10⁷ when both thermodynamic and hydrometeor state variables in the three-dimensional WRF grids over the mesoscale sized weather system are all simultaneously considered. However, restricting the matrix in order to couple errors over only (for example) a 5×5 grid of profiles results in an invertible matrix of size ˜1.5×10⁴ by 1.5×10⁴.

In embodiments, to constrain BEC matrices 359 to a manageable size a parameterized vertical-only flow-dependent approach is initially adopted. For an ensemble of cloud vertical profiles available in the WRF output, each vertical profile may be defined as a single column of M elements for both thermodynamic and cloud hydrometeor state variables at all vertical levels (e.g., M=518 for the 74-level WRF profile). Based on the simple but well-established altitude-density model for clouds and rain cells [5], which is a finite-parameter precipitation cell model, each vertical hydrometeor profile can instead be reasonably well represented by a reduced order vector H of only 15 parameters,

$$\overline{H} = ( 〈 {h}_{i} 〉 , {σ}_{{h}_{i}} , {ρ}_{{h}_{i}} ) , i = [ 1 , ⋯5 ] \qquad ( 3.1 )$$

where [symbol] hᵢ [symbol] denotes the mean of the precipitation cell altitude, σₕ_{ᵢ} denotes the standard deviation of the precipitation cell altitude, ρₕ_{ᵢ} is the column integrated hydrometeor content of the i^{th} hydrometeor category for the cell, and i is the index of five microphysical hydrometeor categories including cloud liquid water, rain, cloud ice, snow and graupel.

Using the above parameterization, an ensemble of vertical hydrometeor profiles may subsequently be classified (e.g., by classifier 340) into multiple hydrometeor modes using clustering analysis methods such as the K-means algorithm. Using K-means, vertical profiles described using the altitude-density representation are optimally partitioned into K clusters (e.g., of clustered state profiles 349) so that a metric distance between the vertical profile set and the assigned cluster means is minimized.

Each cluster thus corresponds to a rain cell “mode” and should contain a number of precipitation profiles greater than the size of the BEC matrix (e.g., of BEC matrices 359) so as to preclude rank deficiency of this matrix. Within each cluster, the covariance of reduced order state variable vector may be estimated using a standard unbiased covariance matrix estimator (e.g., BEC calculator 350). When the mean of the reduced order profile set for in a given cluster is treated as the true state for the corresponding rain cell mode, the covariance matrix estimate provides a simple scaled measure of the BEC matrix for the one-dimensional vertical cloud state vector, given that rain cell is classified as being in that particular mode.

For rain cell vectors that fall at arbitrary locations in reduced order space, a multidimensional (15-dimension) interpolation among cluster covariance matrices is performed to determine the scaled BEC matrix relevant for that specific profile. This clustering analysis method was applied to the WRF-based Midwest storm nature run using the atmospheric state vectors between 2019-05-26 12:00:00 and 2019-05-28 12:00:00 (i.e., 48 hours) at 15-minute time intervals. The state vector of each time frame provided 381×498 cloud profiles with 74 vertical levels. A total of 193 frames of state vectors were created for the clustering analysis, although only a subset of the frames was able to be run within a single ensemble.

The clustering analysis proceeded in two stages: (1) cloud profiles for an individual time frame were partitioned into K clusters using the K-means algorithm, where K=10 or 20, then (2) all cloud profiles within frames between 2019-05-27 15:00:00 and 2019-05-28 12:00:00 were partitioned into 20 clusters. The first part of the analysis identifies the precipitation cell modes at a fixed frame time. Adjusting the number of clusters helps determine the optimal value of K for use in the K-means algorithm, e.g., used by classifier 340. Once the optimal number of clusters for the Midwest storm event is estimated, the second part of the analysis is necessary to identify the primary precipitation modes for the weather event as it evolved over time. In embodiments, and within Kalman filter cycle 308, a BEC matrix for each of K clusters (K clustered state profiles 349) is subsequently estimated by BEC calculator 350 based on the clustering analysis result for the entire weather event.

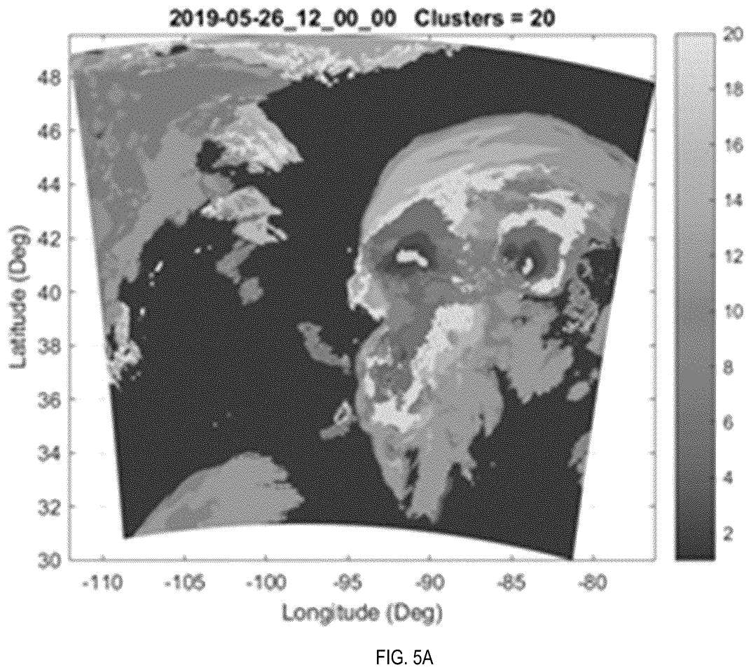

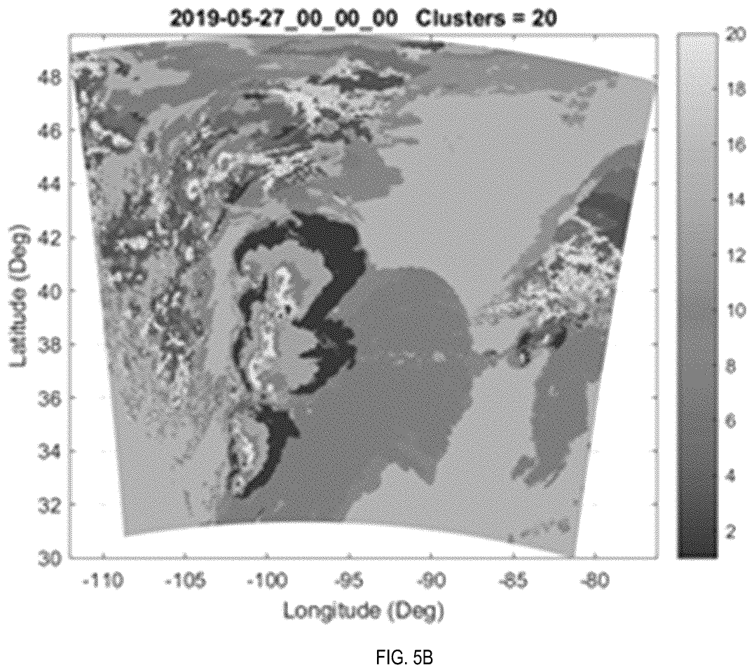

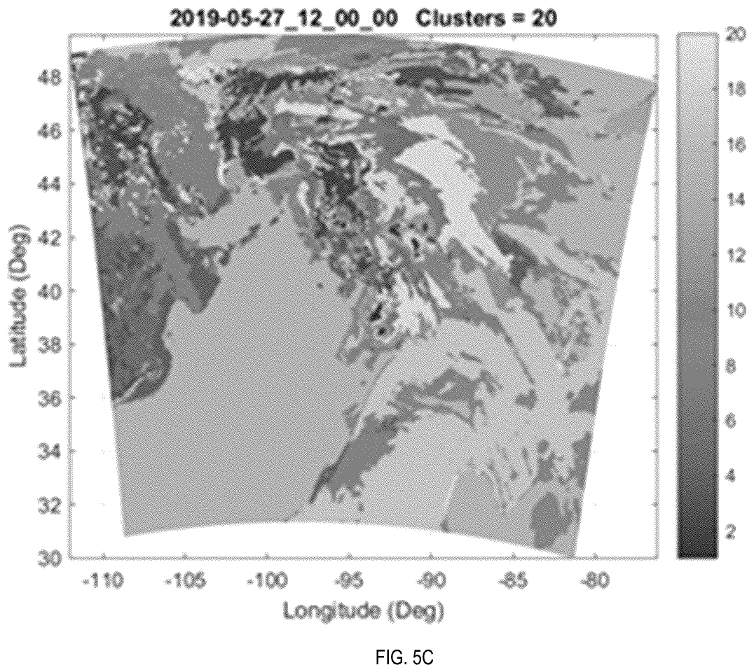

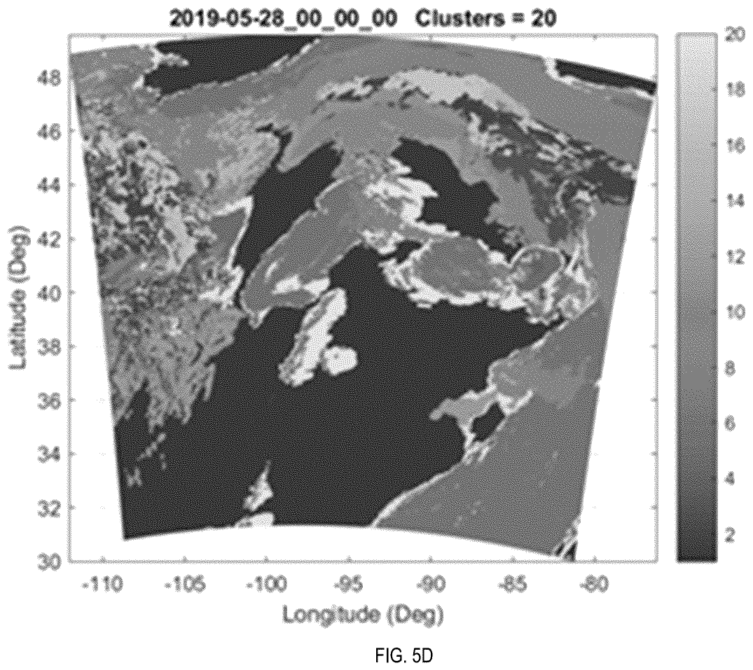

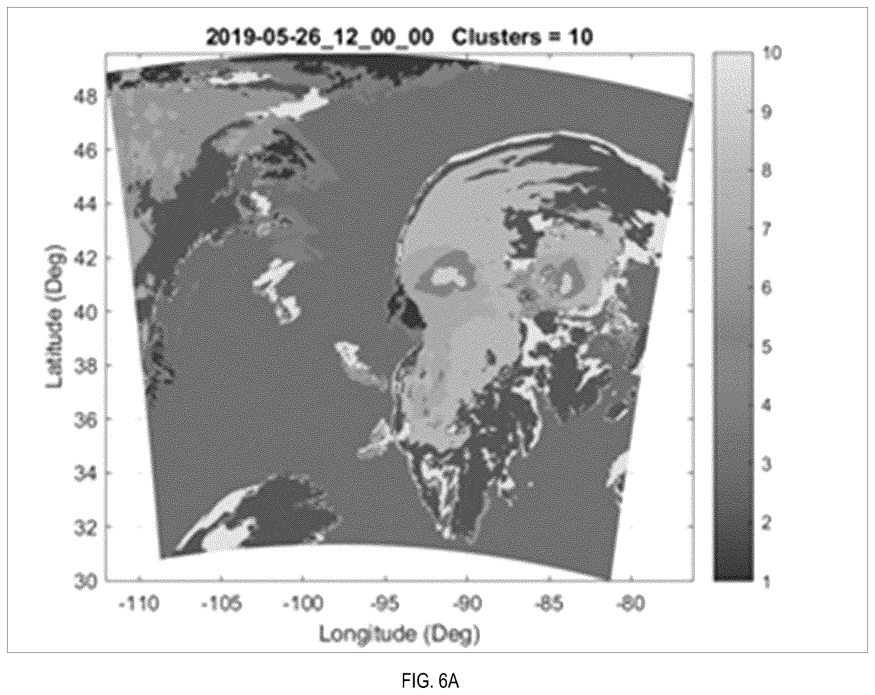

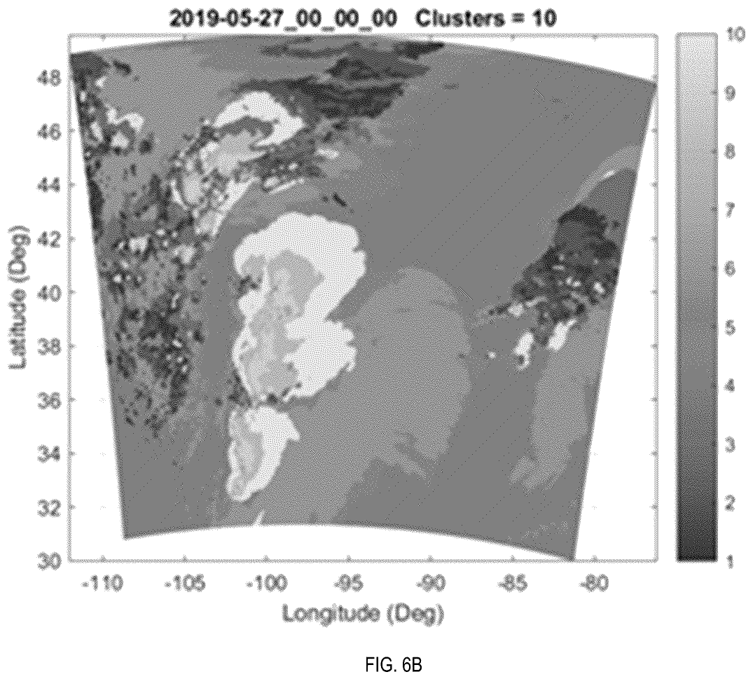

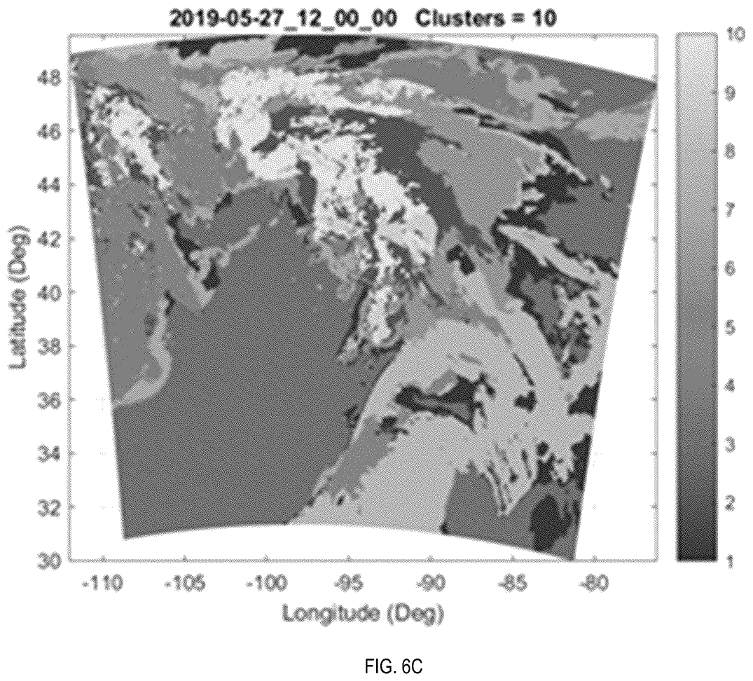

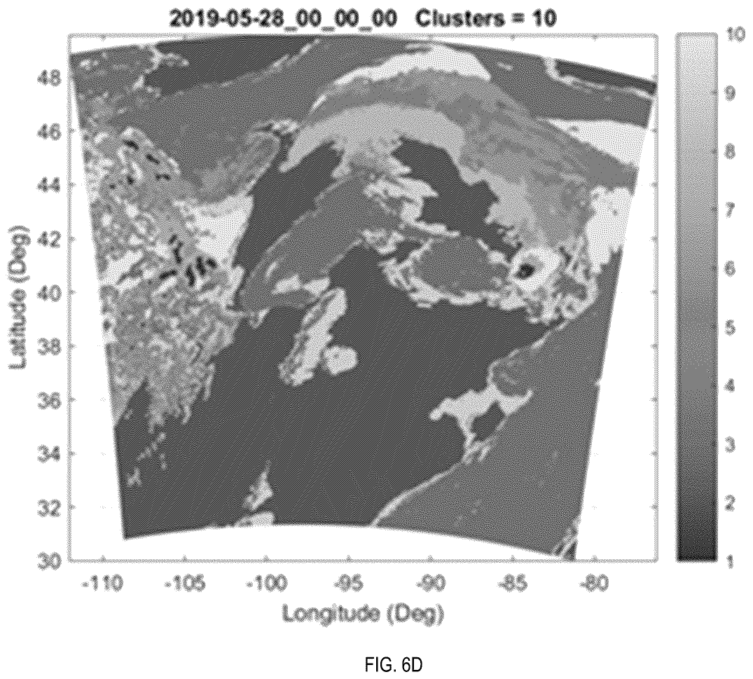

Representative results from the clustering algorithm for K=10 or 20 at four distinct 12-hour time frames are shown in FIGS. 5A-5D and FIGS. 6A-6D. Note that the clusters are not rank ordered in any specific color scheme, thus do not appear to the eye to track convective intensity. However, the images clearly reveal the potential to separate like hydrometeor profile's types within similar rain cell types consistently throughout the duration of the event. Locations of stratiform and convective precipitation tend to appear in contiguous regions that evolve together over time.

The initial performance results suggest an excellent means of grouping cloud and rain cell vertical modes generated by any NWP model into clusters that behave similarly from the standpoints of water distribution and phase. Accordingly, the time evolution and hence stability and predictability of such modes may be incorporated using this method into Kalman gain matrix 336 and iterative state profile updater 366. Since stability and predictability are related to error covariance, it is expected that each of these clusters will have somewhat unique background error covariance matrices that can be subsequently found by clustering, followed by interpolating over a pre-computed scaled library of covariances for the profiles within the specific clusters.

It should be noted that the application of a classification method to develop the clusters (e.g., of cluster database 341) for a representative geophysical state vector ensemble may be an off-line calculation that needs to be done only once (or perhaps occasionally) to build up a covariance library associated with each of clustered state profiles 349. In embodiments, classifier 340 executes the classification method, and the classification may be or include k-means clustering. Moreover, these libraries are of modest size compared to many data elements used in NWP modeling and forecasting. The interpolation applied to this library, by BEC calculator 350 for example, to determine the optimal BEC (e.g., BEC matrices 359) may be a rapid calculation that can be readily performed in real time.

### 3.4 Background Error Covariance Modeling

The rapid evolution of clouds and rain cells associated with frontal convection and hurricane rainbands corresponds to the dominance of the microwave T_{b} signatures relative to temperature and water vapor variations. Therefore, a dynamically varying BEC matrix may be necessary to stabilize assimilation updates at each assimilation cycle. A BEC matrix of BEC matrices 359 may include relevant statistical profile correlation information for the various hydrometeor parameters and phases. In embodiments, this statistical information is relevant to the specific atmospheric state, and thus dynamically vary over the lifetime of and geographic location within a convective event. Importantly, the error covariance for temperature and humidity variations within strongly scattering and absorbing hydrometeors may be artificially suppressed within the BEC matrix for these variables to remain stable within such scenarios during updates.

This suppression may be accomplished by either attenuating or zeroing out the error covariances for the thermodynamic (i.e., temperature and humidity) variables. If all state variables were purely Gaussian and if correct BEC statistics on both the thermodynamic and hydrometeors variables were accurately known, such artificial suppression would be unnecessary when applying an XKF. However, since none of the state variable processes (except for temperature) are Gaussian and BEC statistics are not perfectly known, the suppression of changes in thermodynamic state variables is necessary to stabilize the assimilation step.

In general, such artificial suppression is both applicable and necessary to any state variables that have signatures that are masked by the strong signatures of convective events. Examples of parameters that are masked by convection include Temperature and Humidity variations since scattering by ice in cell tops is strong, ocean surface wind vectors, surface temperature, snow cover, soil moisture, and surface ice. This is even more relevant since the strong signals can change on a 15-minute basis as convection evolves.

Two dynamically varying BEC matrix models may be used in data assimilator 300: (1) a cluster based BEC model, and (2) a Brownian BEC model. BEC calculator 350 may execute either of these models or a combination thereof. Both of these models have the potential to permit rapid library-based calculations of BEC matrices that are continuous functions of the hydrometeor state. Calculation of each model's BEC matrices may then be artificially suppressed to achieve temperature and humidity stability. However, the two methods differ fundamentally in the bases used to calculate the BEC matrix. Section 3.6 describes the Brownian BEC model method. Progress on the cluster-based BEC model validating the utility of the K-means clustering technique is described below in Section 3.5.

### 3.5 Cluster-based BEC Model Validation

Clustering of hydrometeor states using the K-means algorithm was computed in a reduced dimensionality hydrometer state space. The WRF atmospheric profile nature run data set used included of 499×382 grid points with 74 atmospheric levels at five km horizontal resolution. The analysis interval (i.e., archival or output frequency) for the nature run is 15 minutes extending over 48 hours, for 193 snapshot frames. To facilitate clustering each profile containing a total of 900 vertical variables (T, q, and density and mean size for five hydrometeor phases at 74 levels) is reduced to a 15-dimensional hydrometeor space H̅, as described in eqn. (3.1)

Clustering was performed over 20 presumed cluster centers in this 15 dimensional space for the ensemble of all 193 frames. The cluster centers were used to compute individual covariance matrices in the original WRF 900-dimensional space; the clustering process and cluster centers were evaluated for physically consistency with known meso-scale convective behavior. We found that that profiles of the same clusters are associated with similar regions of convection behavior in this diverse mesoscale test case. Distinctly different profiles are classified into different clusters. Cluster member populations vary from a few profiles out of the total of 499×382˜1.9E5 profiles to several tens of thousands, but the distinctions made using K-means clustering clearly suggest a meteorologically relevant classification.

It is precisely this K-means classification capability that permits the development of a state-dependent and dynamically varying background error covariance matrix. This matrix may be computed by optimal interpolation over a fixed library of error covariance matrices defined within the 15D reduced hydrometeor profile space. Under this proposed scheme each 15×5 error covariance matrix in the library is assumed to be proportional to a covariance matrix of hydrometeors for the cluster. In embodiments, unbiased weighted interpolation in 15D space using a Euclidean distance metric and unitary set of weights (similar to that routinely performed in 2D ordinary Kriging) provide the most relevant error covariance matric for use in computing the Kalman gain.

### 3.6 Brownian Background Error Covariance Modeling

In addition to the cluster based BEC model, progress was made in developing the proposed Brownian based background error covariance model. The Brownian BEC model background error covariance model is based on the “NMC method” under which the NWP model state variable increments are small enough that both hydrometeor and thermodynamic state variables can be assumed to be Brownian random processes whose error covariances grow linearly with time. Under the Brownian assumption the covariance matrix is thus developed from increments in the forecast state variables, which are themselves jointly Gaussian for short enough time periods. We have focused in this study on the appropriate time differences to be used to justify the Brownian assumption for both hydrometeor (e.g., rain, cloud liquid water, cloud ice, snow, and graupel density) and thermodynamic variables (e.g. temperature, water vapor) within the framework of the Weather Research and Forecasting (WRF) model, and in particular the determination of the proper scaling factor between the time difference increments and resulting background error covariance matrix.

Assimilating satellite data observed over clouds and precipitation requires second moment joint statistics of hydrometeor variables, in particular the error covariances of the number density and other distribution parameters of typically five hydrometeor microphysical phases (rain, cloud liquid water, cloud ice, snow, and graupel) [6]. The time evolution of the partial water densities and distribution parameters of falling, advecting, convecting, and evolving hydrometeors in clouds is statistically similar to the well-known Brownian motion process [7]. Brownian motion is a continuous random movement of small particles suspended in a dissipative thermal medium under thermodynamic influence of all surrounding molecules [8].

Key features of Brownian behavior are a state variable variance that grows linearly with time and state variable increments that are statistically independent for non-overlapping time intervals. The evolution of NWP model errors for cloud hydrometeors and associated thermodynamic variables (temperature, relative humidity, winds) can analogously be modeled as a stochastic Brownian process over limited time scales due to the inherently noisy and effectively unobservable meteorological phenomena [9] that jointly influence these variables.

The background error covariance matrix is defined as:

$${B}^{=} = 〈 ( {\overline{x}}^{f} - {\overline{x}}^{t} ) ( {\overline{x}}^{f} - {\overline{x}}^{t} ) {〉}^{T} \qquad ( 3.3 )$$

In eqn. 3.3., where x^{f} is a state vector of model forecast variables, x^{t} is the true state of the atmosphere, [symbol] ⋅ [symbol] denotes an ensemble average of model errors. An effective approach to determining B̅, commonly referred to as the “NMC method”, was introduced by the NOAA National Meteorological Center (now the National Center for Environmental Prediction) for estimating thermodynamic state variable error covariance. This approach is regionally dependent and computes joint error statistics using an ensemble of analysis differences between pairs of forecast state variables at differing forecast times [10] [11]. Parrish and Derber [12] illustrate the method with the following ensemble averaging process to estimate the BEC matrix:

$$\hat{{B}^{=}} ∝ < ( {\overline{x}}^{48} - {\overline{x}}^{24} ) {( {\overline{x}}^{48} - {\overline{x}}^{24} )}^{T} > \qquad ( 3.4 )$$

$$\text{where:}$$

$${\overline{x}}^{48} = {M}_{48 ← 0} ( {\overline{x}}^{α} ( t = 0 ) )$$

$${\overline{x}}^{24} = {M}_{48 ← 24} ( {\overline{x}}^{α} ( t = 24 ) ) \qquad ( 3.5 )$$

In the above, x⁴⁸ and x²⁴ are (respectively) the 48 hour and 24-hour forecasts valid at the same forecast time but launched from analyses that are 24 hours apart. The function M_{β←α}(⋅) is the NWP model forward time operator from analysis time β to α, and x^{a}(t) is the state variable vector at analysis time t.

Considering an arbitrary analysis time ti, the updated (or analysis) state vector xₐ(tᵢ) is the best available knowledge of the true state at time tᵢ. The associated forecast and forecast error at later time t; are thus:

$${\overline{x}}^{f} ( {t}_{j} \vert {t}_{i} ) = {M}_{{t}_{j} ← {t}_{i}} {\overline{x}}^{a} ( {t}_{i} ) \qquad ( 3.6 )$$

$$\overline{η} ( {t}_{j} \vert {t}_{i} ) = {\overline{x}}^{f} ( {t}_{j} \vert {t}_{i} ) - {\overline{x}}^{t} ( {t}_{i} )$$

Assuming that the error η is a jointly Brownian process its covariance matrix grows linearly in time:

$$〈 \overline{η} ( {t}_{j} \vert {t}_{i} ) {\overline{η} ( {t}_{j} \vert {t}_{i} )}^{T} 〉 = {A}^{=} ( {t}_{j} - {t}_{i}^{′} ) = {A}^{=} ( {t}_{j} - {t}_{i} + δ t ) \qquad ( 3.7 )$$

where A is a joint error growth rate matrix and δt is a time origin offset. An example of Brownian error growth for two state variables is illustrated in FIG. 3, an estimate for B(tᵢ) can be based on forecast differences as follows:

$$\begin{matrix}{B}^{\hat{=}} ( {t}_{i} ) & = {A}^{\hat{=}} ( {t}_{i} - {t}_{i - 1} + \hat{δ t} ) \\ & = {A}^{\hat{=}} ( Δ T + \hat{δ t} )\end{matrix} \qquad ( 3.8 )$$

where ΔT is the analysis time increment. The time offset and growth rate matrix estimates can be found by regression to the statistics of the NWP model state differences δx(tₖ|tⱼ,tᵢ) of the form:

$$\begin{matrix} & 〈 δ \overline{x} ( {t}_{k} \vert {t}_{j} , {t}_{i} ) δ {\overline{x}}^{T} ( {t}_{k} \vert {t}_{j} , {t}_{i} ) 〉 \\ = & {A}^{=} ( {t}_{k} - {t}_{i} + δ t ) + {A}^{=} ( {t}_{k} - {t}_{j} + δ t ) \\ = & {A}^{=} ( 2 {t}_{k} - {t}_{i} - {t}_{j} + 2 δ t )\end{matrix} \qquad ( 3.9 )$$

$$where$$

$$δ \overline{x} ( {t}_{k} \vert {t}_{j} , {t}_{i} ) {=}^{Δ} \overline{η} ( {t}_{k} \vert {t}_{i} ) - \overline{η} ( {t}_{k} \vert {t}_{j} ) \qquad ( 3.1 )$$

Key to the above method are the assumptions of Brownian error growth and uncorrelated forecast errors. It is noted that identification of the time offset variable entails nonlinear functional minimization rather than pure linear regression.

### 3.8 Radiative Transfer Model Parallelization

In embodiments, radiative transfer model 320 has one or more of the following properties:
1. capability to accurately model the scattering and absorbing characteristics of the five primary hydrometeor phases of rain, cloud liquid water, graupel, cloud ice, and snow at frequencies up to ˜500 GHz,
2. capability to accurately calculate the upwelling top-of-atmosphere plane-parallel radiances for up to at least eight Gaussian quadrature stream angles under arbitrary single-scattering albedo conditions,
3. a rapid geophysical and radiative Jacobian calculation for all hydrometeor parameters along with temperature and humidity, and
4. ability to perform forward transfer and Jacobian calculations on moderate (i.e., 16-256 core) parallel processing machines at an average time of ˜0.1 msec per profile for 74-level profiles and up to ˜40 channel frequencies.

### 3.9 Hydrometeor Profile Parameter Estimation

Data assimilator 300, e.g., classifier 340, may leverage clustering to reduce the number of estimated hydrometeor variables. The WRF model was configured to use 74 atmospheric levels with 12 unknown state variables (density, mean size, and temperature and humidity) at each level, resulting in 900 potential unknowns per profile. The number of microwave spectral channels using GEMS-2 may be 24, leading to the potential for an unstabilized XKF inversion without proper conditioning. In order to stabilize this inversion, the reduction of each profile into a 3-dimensional hydrometeor vector including total (integrated) column mass, peak height, and height standard deviation is being studied.

In embodiments, data assimilator 300 constrains the number of estimated parameters by separately estimating the cloud vertical structure including small cloud liquid water (CLW) and ice particles and the precipitation vertical structure including larger rain, snow, and graupel particles. Frozen hydrometeors always lie above the altitude of homogeneous nucleation (h_{H}) and liquid hydrometeors lie below the melting level (h_{M}) at 0° C. The altitude of homogeneous nucleation h_{H} is typically at a temperature of −40° C. In between h_{M} and h_{H} the mass fraction of liquid versus frozen hydrometeors varies linearly [13]. This altitude-density model distributes both the phase and mass of precipitation according to a physically meaningful parametrized model. A mixed layer with both liquid and frozen hydrometers is assumed within the height range between freezing and homogeneous nucleation.

An ab initio approximation to the altitude density model assumes cloud liquid and frozen hydrometeors (i.e., small hydrometeors) distributed in the approximate vertical distribution shown and a separate profile of rain, graupel, and snow (i.e., large hydrometeors) similarly distributed. Accordingly, this approximate altitude density (AAD) model involves a total of six hydrometeor parameters for each profile: total column mass, peak height, and height standard deviation for each of cloud and precipitating hydrometeors; thus, reducing the number of degrees of freedom in each profile by a factor of (74×10)/6≈123. This dimensional reduction constrains the inversion, resulting in the requirement of a 6×6 BEC matrix in this embodiment.

$$D = {D}_{tot} B ( α ) α = \frac{z - {z}_{peak}}{Δ z} , \qquad ( 3.11 )$$

Under the AAD model the vertical distribution of clouds and precipitation are represented using a density function, where D is the density function (g m⁻²), Dₜₒₜ is the total column hydrometeor mass (g/m²), B is a basis function (dimensionless), α is a normalized vertical coordinate (unitless), z is the height above the surface (km), zₚₑₐₖ is the height of maximum hydrometeor density (km), and Δz is the hydrometeor standard deviation (km). The basis function B represents the assumed vertically spread distribution of hydrometeor density. Consider a hydrometeor layer divided into sublayers. Assuming a uniform distribution of hydrometeors within each sublayer, where ρᵢ is the hydrometeor density for the i^{th} sublayer, δzᵢ is the thickness of the sublayer, and fᵢ is the fraction of total column hydrometeor mass in the layer.

$${ρ}_{i} = ( {D}_{tot} / δ {z}_{i} ) {f}_{i} \qquad ( 3.12 )$$

Hydrometeor state vector update studies will focus on three forms of the basis function, B: Gaussian, Cubic B-spline, and quadratic. All three represent continuous functions with continuous derivatives, thus permitting association of AAD model derivatives with the Jacobians that connect the radiance observations using the chain rule with hydrometeor densities for phases of small and large hydrometeors. WRF profiles and radar observations suggest that clouds and precipitation nomically truncated vertical distributions, thus favoring either the quadratic or cubic B-spline basis function. Any retrieval or data assimilation requires a Jacobian as part of the optimization scheme to estimate Dₜₒₜ, zₚₑₐₖ, and Δz. Accordingly, the chain rule may be used to calculate the required Jacobians:

$$\frac{\partial {T}_{bj}}{\partial {D}_{tot}} = \frac{\partial {T}_{bj}}{\partial {ρ}_{i}} \frac{\partial {ρ}_{i}}{\partial {D}_{tot}} \qquad ( 3.13 )$$

$$\frac{\partial {T}_{bj}}{\partial {z}_{peak}} = \frac{\partial {T}_{bj}}{\partial {ρ}_{i}} \frac{\partial {ρ}_{i}}{\partial {z}_{peak}} ,$$

$$\frac{\partial {T}_{bj}}{\partial Δ z} = \frac{\partial {T}_{bj}}{\partial {ρ}_{i}} \frac{\partial {ρ}_{i}}{\partial Δ z}$$

where T^{bj} is brightness temperature for channel j and ρᵢ is the hydrometeor density for sublayer i. The DOTLRT forward model being used data assimilator 300 calculates the geophysical and radiation Jacobian of T_{bj} with respect to ρᵢ. The overall approach thus preserves the utility of the Jacobian method in calculating the Kalman gain while reducing the number of estimated variables and leveraging the simplicity of the clustering technique to find the appropriate BEC matrix. Jacobian model 322 may use one or more Jacobians of eq. (3.13)

For precipitation, the AAD model slightly over estimated rain below the freezing level and slightly underestimated snow and graupel above the freezing level. The estimated precipitation peaks near the surface at zₚₑₐₖ=0.4 km. The estimated profile also misses small snow and graupel densities above 4 km due to the vertical constraint imposed by the basis function.

### 3.10 Jacobian Calculations and Assessments

Radiative transfer model 320 may use a DOTLRT forward RT model to develop initial all-weather microwave assimilation demonstrations. The DOTLRT model may incorporate a fast Jacobian calculation that is currently being assessed and improved in both speed and interoperability with WRF for operational use. The assessment includes determining the accuracy of the Jacobian calculation for temperature, water vapor, and precipitation parameter derivatives.

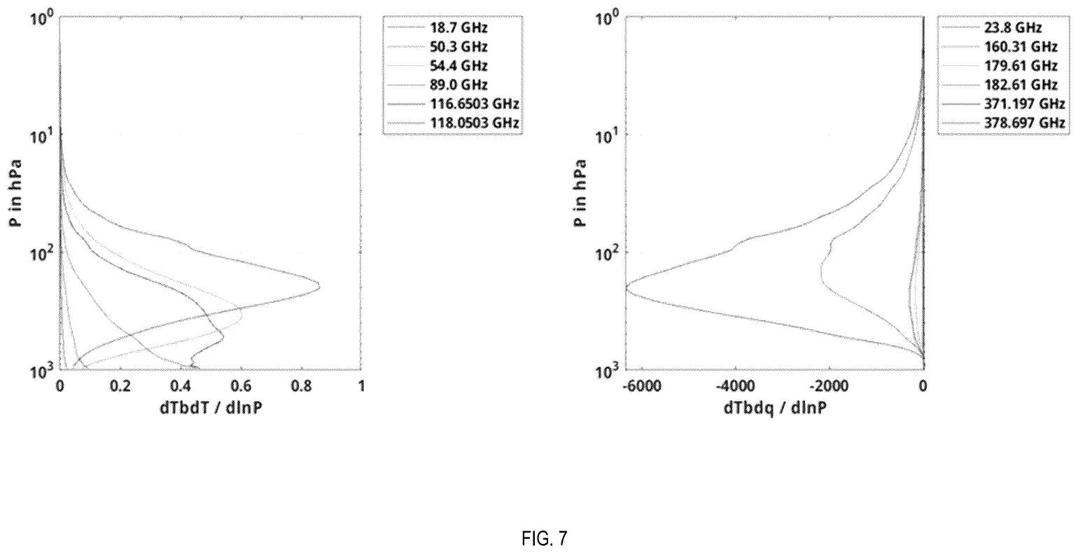

FIG. 7 shows the vertical temperature and water vapor Jacobians for a typical WRF clear-air profile from the Midwest convection nature run. The Jacobian functions were obtained using DOTLRT for selected microwave temperature and moisture sounding channels and for a typical clear-air WRF profile: (left) temperature Jacobian, and (right) water vapor Jacobian. A representative set of temperature and moisture sounding channels were selected for these plots, which are for a 37.6° stream propagation angle and non-reflecting blackbody surface. In both cases the expected performance is displayed, with the incremental response functions being positive for temperature and negative for water vapor.

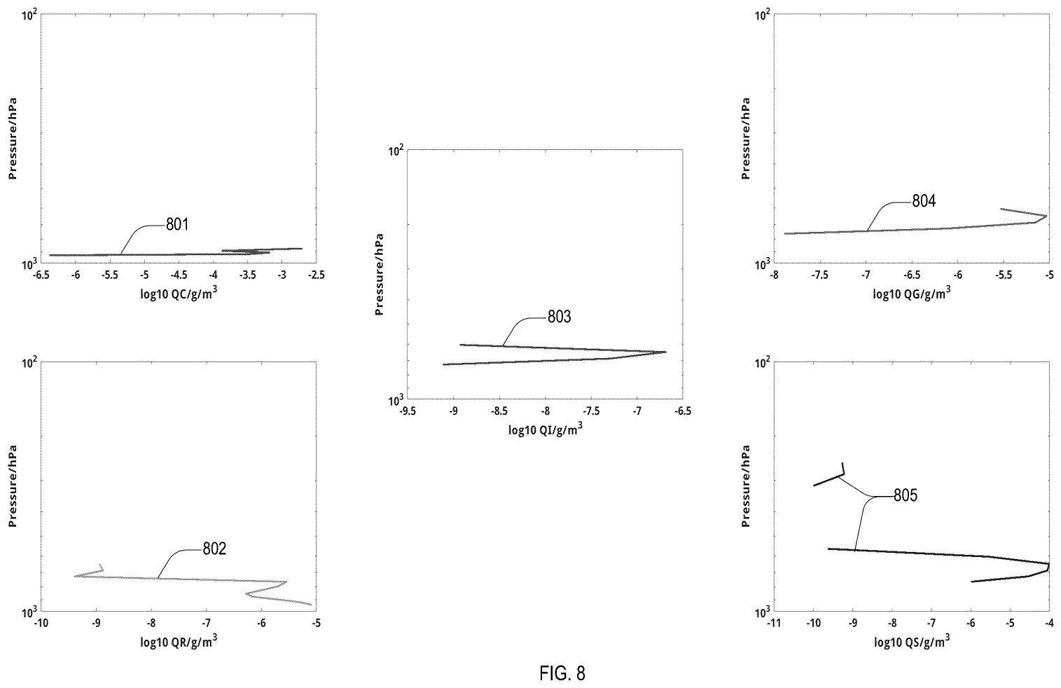

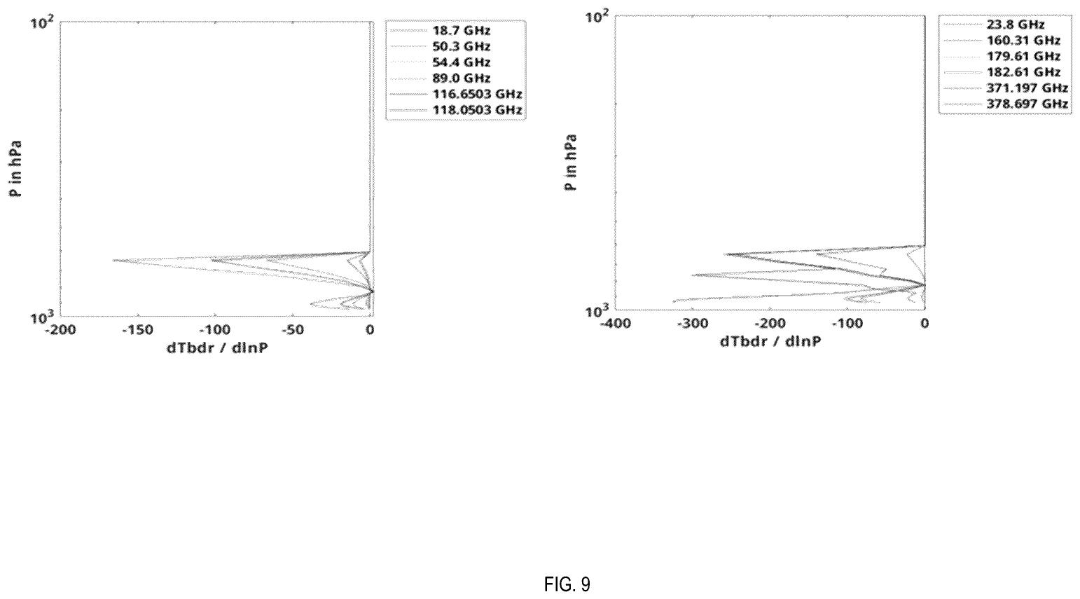

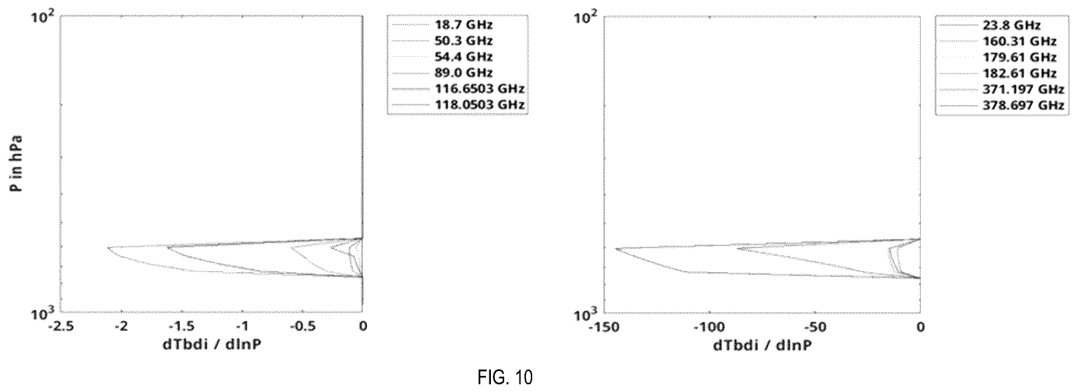

A more demanding test is the calculation of the Jacobian for scattering and absorbing hydrometeors, which is also coded into the DOTLRT algorithm. This capability was studied using a precipitating hydrometeor profile with vertical densities as shown in FIG. 8 for all hydrometeor phases. FIG. 8 graphically illustrates vertical hydrometeor distributions for a precipitating profile used for hydrometeor Jacobian tests. FIG. 8 includes curves 801-805 for cloud water (curve 801), rain (curve 802), cloud ice (curve 803), graupel (curve 804), and snow (curve 805). While some code sections that produce spurious behavior are still being corrected, the general behavior of the Jacobians (FIG. 9 and FIG. 10 for rain and cloud ice, respectively) indicate expected incremental response sign and spectral trends. In FIGS. 9 and 10, the zenith angle of propagation is 37.6°.

### 3.11 Radiative Transfer Model Speedup

Radiative transfer model 320 may include and/or utilize the DOTLRT model. DOTLRT incorporates the relevant physics to estimate hydrometeor distributions, but currently performs full Mie series calculations that make is impractical for operational data assimilation. Our strategies focus on (i) the integration of Mie library lookup tables [1] and (ii) reducing the number of atmospheric layers for altitudes where there are unquestionably no hydrometeors present.

With regard to the first of these strategies, the DOTLRT when implemented by radiative transfer model 320, may execute the Mie scattering routine for every layer and every hydrometeor type, typically accounting for more than half of the overall forward RT calculation execution time. However, this calculation is deterministic with only three inputs of frequency, hydrometeor density and temperature. Since calculations are needed at only a discrete set frequency associated with the mid-band frequency of each microwave channel a set of lookup tables (one for each channel) and bilinear interpolation is being implemented to calculate absorption and scattering coefficients κₐ and κ₃ (respectively) and phase matrix asymmetry parameter g as a function of hydrometeor density and temperature in less than 1% of the time required by the full Mie routine.

With regard to the second strategy, the WRF vertical grid extends well into the stratosphere, but convection is rarely present above ˜20 km altitude. Over most convection, processing the non-scattering stratospheric layers increases execution time but has little influence on the Kalman gain for the hydrometeor state vector components. A suitable condition based upon the atmospheric hydrometeor state vector is being sought to determine when scattering above a dynamically variable cloud top altitude height can be safely neglected in Jacobian (and hence Kalman gain) calculations. For channels and state vectors when this condition is achieved the lower-atmosphere DOTLRT model may be used in conjunction with a faster stratospheric model component to reduce overall profile execution time by an expected value of between 25% and 75% on average.

In embodiments, the Kalman filter equations for a single cycle of Kalman filter cycle 308 are given by equations (3.14)-(3.16) [14].

### Analysis Increment:

$${\overline{x}}^{a} ( {t}_{i} ) = {\overline{x}}^{f} ( {t}_{i} ) + {{K}^{=}}_{i} ( {\overline{y}}_{i} - \overline{h} ( {\overline{x}}^{f} ( {t}_{i} ) ) ) \qquad ( 3.14 )$$

$$Forecast : {\overline{x}}^{f} ( {t}_{i + 1} ) = \overline{A} ( {\overline{x}}^{a} ( {t}_{i} ) ) \qquad ( 3.15 )$$

$$Kalman Gain : {{K}^{=}}_{i} = {{B}^{=}}_{i}^{f} {{{H}^{=}}_{i} ( {{R}^{=}}_{i} + {{H}^{=}}_{i} {{B}^{=}}_{i}^{f} {{H}^{=}}_{i}^{t} )}^{- 1} \qquad ( 3.16 )$$

In equations, 14-16, xₐ is the analysis (or updated) state vector, x_{f} is the background forecast state vector, y is the multispectral GEMS satellite Tₐ observation vector simulated from the nature run data, h is the predicted model vector using the forward radiative transfer (UMRTv4, including instrument antenna patter convolution), Ā is the time evolution prediction operator (WRF run for 15 minute time steps tᵢ₊₁−tᵢ), K̅ᵢ is the Kalman gain matrix (e.g., matrix 336), B̅_{f} is the BEC matrix (appropriately scaled from the interpolated state vector covariance estimate), H=HᵢHᵣH_{g} is the full Jacobian (geophysical H_{g}, radiation Hᵣ, and instrument Hᵢ), and R is the GEMS sensor noise covariance matrix.

These equations provide the framework for integrating the flow-dependent BEC, full Jacobian, and simulated GEMS observations into an update cycle (e.g., 15 minutes) relevant to the planned GEMS satellite constellation. The matrices, matrix storage, inversion, and multiplication operations, all are able to be supported by a moderately sized multiprocessor, e.g., processor 286. These equations are capable of being run in real time for moderately sized domains (typically 1500×1500 km) using the WRF model or its operational equivalents and being used for short-term convective forecasting at 15-minute update intervals.

In embodiments, forecasted state profiles 319 includes a parameterized hydrometeor state vector. This state vector may be augmented to include adjacent parameterized profiles is a straightforward extension of the method that permits clustering of spatially correlated hydrometeor profiles. Calculations using these extensions are the focus of our future internal development efforts to commercialize the weather prediction method and are based upon iterative sweeping across the domain of interest within each XKF update but require increasing the dimensions of the BEC by a factor of (typically) 3×3=9 to see meaningful results. To study longer horizontal correlation lengths, the number of vertical levels and/or vertical resolution will need to be reduced, possibly using either Principal Components Analysis (PCA) rank reduction, upper-level truncation, and/or performing updates in the reduced-order altitude density model space.

The scaling of covariance within an arbitrarily selected set of K clusters to estimate a BEC matrix (e.g., of BEC matrices 359) deserves some discussion. To this end, consider the determinants of the covariance and subcovariance matrices for the various K rain cell modes. Clearly, the larger the number of clusters K, the smaller will be each of these determinants, with the determinant scaling approximately as 1/K. To demonstrate this, consider the overall reduced-order rain cell signal energy distributed as a constant, but when clustered is distributed over K sets. Thus, presuming that this energy is approximately uniformly distributed over the various clusters, in embodiments the interpolated covariance matrices (BEC matrices 359) are themselves initially scaled by 1/K—which is an arbitrary number that will grow as the diversity of rain call vectors in any given training set increases.

This problem of scaling may be circumvented by recognizing that the interpolated covariance matrices (provided that K is selected to be large enough to provide a nearly continuous discretization of rain cell modes) may be arbitrarily scaled, and thus (1) represent correlations between rain cell parameter variations that are critical to preserve in any Kalman filter update (via Kalman filter cycle 308), and (2) need to be scaled by an arbitrary tuning factor when used as BEC matrices 359 in a Kalman filter cycle 308. However, since the update may be performed using the extended Kalman filter, a suitably small, scaled update is necessary to both convergence and stability of the XKF cycle. Thus, method 400 may include the use of a single tuning factor, or a small number of such factors (e.g., one each for temperature, water vapor, and rain cell parameter covariance) along with the interpolated BEC matrix.

The scaling relationship between error covariance and state covariance may be important to ensuring the stability of thermodynamic state variable updates within clouds and rain cells. In this manner, it may offer an effective means of performing all-weather radiance assimilation wherein the sensitivity of upwelling radiances to hydrometeors dominates that of temperature and humidity, but these variables of lesser sensitivity still needs to be treated as they would in clear air conditions—albeit with much smaller Kalman gains to ensure their stability.

3.12 Prototype Results from Cluster Based Background Error Covariance Method

During the prototyping process, cluster #3 and cluster #6 from the Midwest storm nature run was chosen as the source for a few select visualizations. Note that the number label of clusters is entirely arbitrary.

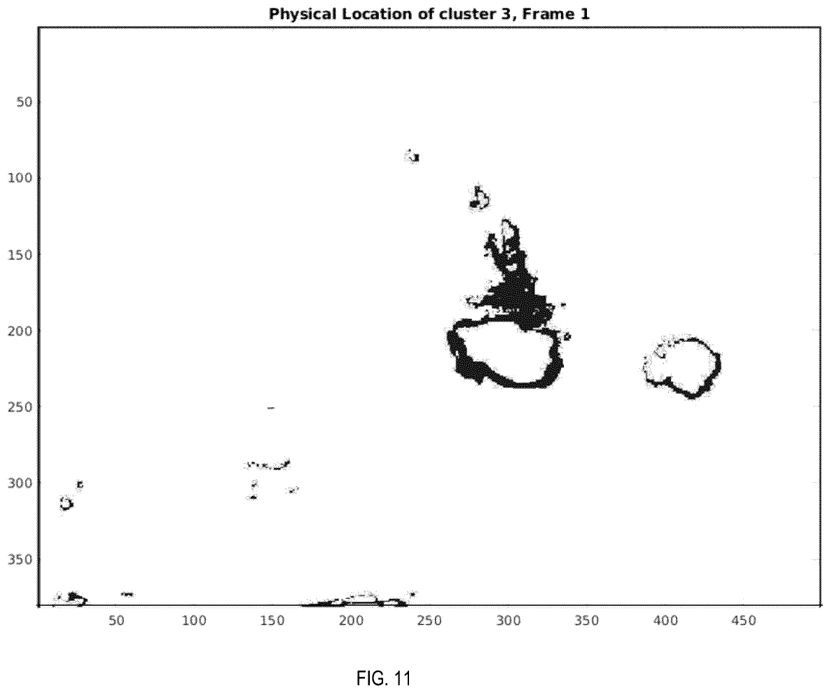

FIG. 11 shows the physical location of cluster #3 in the first frame of the Midwest storm. The ring-like distribution is indicative of moderate to heavy convective activity. These rings encircle storm centers. Other clusters inside of the ring exhibit even more extreme weather, while clusters outside of the ring exhibit milder weather.

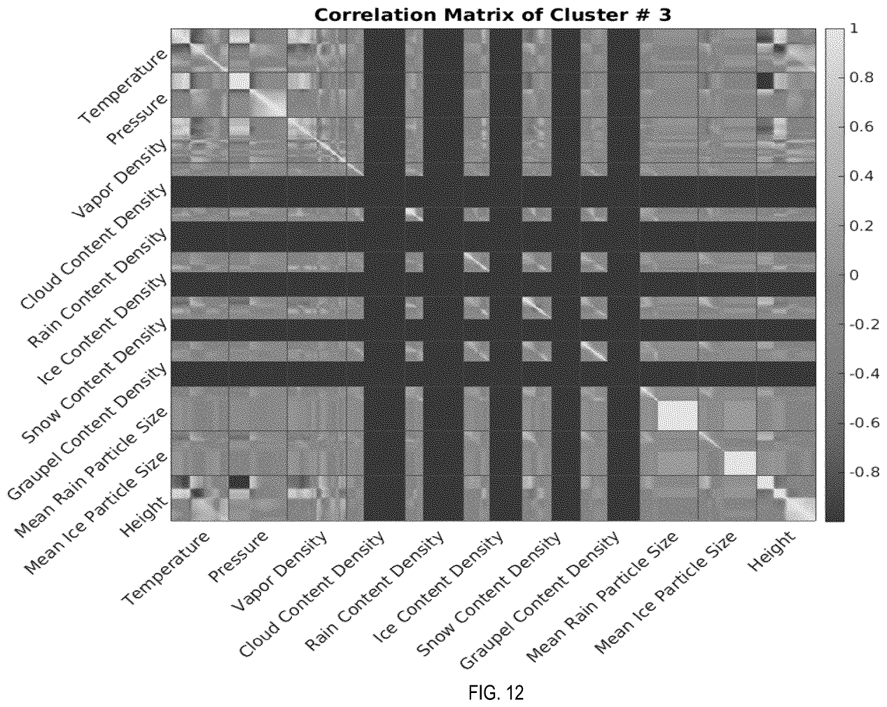

FIG. 12 is the correlation matrix for cluster #3, which may be computed from a BEC matrix 359 for cluster #3. There are 11 key parameters being tracked at each of the 74 vertical atmospheric layers for a total of 814 variables. The overlaid red grid demarcates subblocks of correlations of particular parameters across the vertical atmospheric profile. This matrix is laid out so that moving to the right or downwards within a subblock corresponds to referencing the correlation of parameters at higher altitudes. The dark blue stripes through the middle of the matrix reflect the fact that hydrometeors are not present above a certain altitude, and therefore the correlation data for these points does not have physical meaning.

This matrix condenses many atmospheric features into a single data block; for example, by examining the most upper left subblock, representing correlations of temperature vs. temperature across different altitudes. The tropopause shows up as a boundary between positive and negative correlations.

As a check on whether the clusters are meaningful representations of weather events, high-energy modes of the covariance matrix were examined. First, the on-diagonal subblocks of the larger covariance matrix were extracted (i.e. the blocks containing information about correlations of a single parameter vs. itself across different altitudes) and an eigenvector decomposition was performed on each subblock.

While FIG. 12 does not represent a visualization of all the data features that are captured by the full covariance matrix, it still provides a view into the dominant behavior of this particular cluster. A plot such as this one was generated and examined for each of the 21 clusters, all of which show meaningful features for their respective physical locations within the storm.

When data for a new atmospheric profile enters weather predictor 200, one of the first steps is computing a covariance matrix for that particular profile. To this end, a modified Euclidean mean between that profile and the centroids of each of the clusters in the covariance library is computed. The covariance matrix (e.g., of BEC matrices 359) for the incoming profile may be computed as a weighted average of all of the covariance matrices in the library, e.g., of clustered state profiles 349. A weight used in the weighted average may equal zero if not relevant.

### REFERENCES

[1] Tian, M, and AJ Gasiewski (2013), A Unified Microwave Radiative Transfer Model for General Planar Stratified Media, IEEE Transactions on Geoscience and Remote Sensing, Vol. 51, No 7, 4103-4118.
[2] Voronovich, AG, AJ Gasiewski, and BL Weber (2004), A Fast Multistream Scattering-Based Jacobian for Microwave Radiance Assimilation, IEEE Transactions on Geoscience and Remote Sensing, Vol. 42, No. 8, 1749.
[3] Liebe, Hans J. (1989), MPM—An atmospheric millimeter-wave propagation model, International Journal of Infrared and Millimeter Waves, Vol 10, 631-650.
[4] Sandeep, S, and AJ Gasiewski (2012), Fast Jacobian Mie Library for Terrestrial Hydrometeors, IEEE Transactions on Geoscience and Remote Sensing, Vol. 50, No. 3, 747.
[5] Janssen, Michael A., AJ Gasiewski, et al. (1993), Atmospheric Remote Sensing By Microwave Radiometry, Wiley Series In Remote Sensing, Chapter 3.
[6] Reisner, J., R. M. Rasmussen, and R. T. Bruintjes. 1998. “Explicit Forecasting of Supercooled Liquid Water in Winter Storms Using the MM5 Mesoscale Model.” Quarterly Journal of the Royal Meteorological Society 124 548: 1071-1107. https://doi.org/10.1002/qj.49712454804.
[7] A brief account of microscopical observations made in the months of June, July and August 1827, on the particles contained in the pollen of plants, and on the general existence of active molecules in organic and inorganic bodies. https://www.math.utah.edu/davar/REU-2002/notes/lec8.pdf
[8] Georg A. Grell, Dezsõ Dévényi. A generalized approach to parameterizing convection combining ensemble and data assimilation techniques. Geophysical research letters, Vol. 29, NO. 14, 1693, 10.1029/2002GL015311, 2002.
[9] Shutts G. 2005. A kinetic energy backscatter algorithm for use in ensemble prediction systems. Q. J. R. Meteorol. Soc. 131: 3079-3102.
[10] Buehner M, Gauthier P, Liu Z. 2005. Evaluation of new estimates of background and observation error covariances for variational assimilation. Q. J. R. Meteorol. Soc. 131: 3373-3384.
[11] Ingleby NB. 2001. The statistical structure of forecast errors and its representation in the Met Office global three-dimensional variational data assimilation system. Q. J. R. Meteorol. Soc. 127: 209-231.
[12] Parrish and Derber. The National Meteorological Center's Spectral Statistical-interpolation analysis system. Monthly weather review, 1992: Vol 120:1747-1763
[13] Gasiewski, A. J. “Numerical Sensitivity Analysis of Passive EHF and SMMW Channels to Tropospheric Water Vapor, Clouds, and Precipitation,” IEEE Trans. Geosci. Remote Sensing, vol. 30, no. 5, pp. 859-870, September 1992.
[14] Kalnay, E “4-D-Var or ensemble Kalmar filter?” DOI: 10.1111/j.1600-0870.2007.00261.x

### List of Symbols, Abbreviations and Acronyms

| | |
|---|---|
| AAD | Approximate Altitude Density |
| BEC | Background Error Covariance |
| DOTLRT | Discrete Ordinate Tangent Linear Radiative Transfer |
| GEMS | Global Environmental Monitoring System |
| GEMS2 | Global Environmental Monitoring System, 2^{nd} Generation |
| NMC | National Meteorological Center |
| NOAA | National Oceanic and Atmospheric Administration |
| NWP | Numerical Weather Prediction |
| OSSE | Observation System Simulation Experiment |
| Tₐ | Antenna Temperature |
| T_{b} | Brightness Temperature |
| UMRT | Unified Microwave Radiative Transfer model |
| WRF | Weather Research and Forecasting |
| XKF | eXtended Kalman Filter |

Regarding instances herein of the terms “and/or” and “at least one of,” for example, in the cases of “A and/or B” and “at least one of A and B,” such phrasing encompasses the selection of (i) A only, or (ii) B only, or (iii) both A and B. In the cases of “A, B, and/or C” and “at least one of A, B, and C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

We claim:

1. A weather prediction method, comprising:
generating radiance differences as a difference between measured radiances from satellites and forecast satellite radiances generated by a radiative transfer model and forecasted state profiles output by a numerical weather prediction (NWP) model; and
when the radiance differences exceed a noise threshold, generating updated state profiles by:
generating radiance-sensitivities using a Jacobian model and the forecasted state profiles;
constructing a Kalman-gain matrix from background error covariance (BEC) matrices and the radiance-sensitivities;
generating filtered state-profile changes from the Kalman-gain matrix and the radiance differences; and
updating the state profiles by adding the filtered state-profile changes to the forecasted state profiles to yield the updated state profiles.

2. The method of claim 1, further comprising (i) repeating the step of generating radiance differences to yield updated radiance differences, where the updated state profiles replace the forecasted state profiles, and (ii) repeating the step of generating updated state profiles when the updated radiance differences exceed the noise threshold.

3. The method of claim 1, further comprising, when the radiance differences are less than a noise threshold based on noise from each of the satellites, the radiative transfer model and the NWP model:
generating subsequent forecasted state profiles with the NWP model and the forecasted state profiles as input thereto; and
repeating the step of generating radiance differences, where the subsequent forecasted state profiles replace the forecasted state profiles.

4. The method of claim 1, the forecasted state profiles including, for each of a plurality of horizontal grid points within a regionally defined domain, vertical state profiles of a plurality of state profile variables, the plurality of state profile variables being selected from the group including air temperature, humidity, altitude, hydrometeor density, hydrometeor size, vapor density, cloud content density, rain content density, ice content density, snow content density, graupel content density, mean rain particle size, and mean ice particle size.

5. The method of claim 4, said updating the state profiles comprising updating each state profile variable of the vertical state profiles.

6. The method of claim 4, after repeating the step of generating radiance differences to yield updated radiance differences, and when the updated radiance differences exceed the noise threshold, repeating the step of generating the updated state profiles.

7. The method of claim 6, each of the plurality of state profile variables having a respective one of a plurality of correlation times, a time duration between generating the updated state profiles and repeating the step of generating the updated state profiles being less than a shortest correlation time of the plurality of correlation times.

8. The method of claim 4, when constructing the Kalman-gain matrix, each BEC matrix of the BEC matrices including a covariance between each state profile variable of the plurality of state profile variables.

9. The method of claim 8, the plurality of state profile variables including air temperature, humidity and at least one of altitude, hydrometeor density, hydrometeor size, vapor density, cloud content density, rain content density, ice content density, snow content density, graupel content density, mean rain particle size, and mean ice particle size.

10. The method of claim 1, further comprising, before generating the radiance differences, generating the forecast satellite radiances with the radiative transfer model.

11. The method of claim 1, further comprising generating the background error covariance (BEC) matrices by interpolating the updated state profiles over a library of clustered state profiles obtained by a classification method.

12. The method of claim 1, generating the filtered state-profile changes (i) yielding unscaled filtered state-profile changes and (ii) further comprising scaling the unscaled filtered state-profile changes to yield the filtered state-profile changes.

13. The method of claim 1, updating the state profiles further comprising removing, from the updated state profiles, updated state profiles that are not physically realizable.

14. The method of claim 1, the filtered state-profile changes being a product of the Kalman-gain matrix and the radiance differences.

15. A weather predictor comprising:
a processor; and
a memory storing machine-readable instructions that, when executed by the processor, control the processor to:
generate radiance differences as a difference between measured radiances from satellites and forecast satellite radiances generated by a radiative transfer model and forecasted state profiles output by a numerical weather prediction (NWP) model; and
when the radiance differences exceed a noise threshold, generate updated state profiles by:
generating radiance-sensitivities using a Jacobian model and the forecasted state profiles;
constructing a Kalman-gain matrix from background error covariance (BEC) matrices and the radiance-sensitivities;
generating filtered state-profile changes from the Kalman-gain matrix and the radiance differences; and
updating the state profiles by adding the filtered state-profile changes to the forecasted state profiles to yield the updated state profiles.

16. The weather predictor of claim 15, the memory further storing machine-readable instructions that, when executed by the processor, control the processor to:
repeat the step of generating radiance differences to yield updated radiance differences, where the updated state profiles replace the forecasted state profiles, and
repeat the step of generating updated state profiles when the updated radiance differences exceed the noise threshold.

17. The weather predictor of claim 15, the memory further storing machine-readable instructions that, when executed by the processor, control the processor to, when the radiance differences are less than a noise threshold based on noise from each of the satellites, the radiative transfer model and the NWP model:
generate subsequent forecasted state profiles with the NWP model and the forecasted state profiles as input thereto; and
repeat the step of generating radiance differences, where the subsequent forecasted state profiles replace the forecasted state profiles.

18. The weather predictor of claim 15, the forecasted state profiles including, for each of a plurality of horizontal grid points within a regionally defined domain, vertical state profiles of a plurality of state profile variables, the plurality of state profile variables being selected from the group including air temperature, humidity, altitude, hydrometeor density, hydrometeor size, vapor density, cloud content density, rain content density, ice content density, snow content density, graupel content density, mean rain particle size, and mean ice particle size.

19. The weather predictor of claim 15, the memory further storing machine-readable instructions that, when executed by the processor, control the processor to:
generate the background error covariance (BEC) matrices by interpolating the updated state profiles over a library of clustered state profiles obtained by a classification method.

20. The weather predictor of claim 15, the filtered state-profile changes being a product of the Kalman-gain matrix and the radiance differences.
